(19) United States
(12) Patent Application Publication
(10) Pub. No.: US 2016/0055292 A1
(43) Pub. Date: Feb. 25, 2016

(54) METHODS FOR QUANTITATIVE ANALYSIS OF CELL SPATIAL TRAJECTORIES

(71) Applicant: GEORGIA TECH RESEARCH CORPORATION, Atlanta, GA (US)

(72) Inventors: Douglas White, Atlanta, GA (US); Melissa Kemp, Atlanta, GA (US); Todd Christopher McDevitt, Atlanta, GA (US)

(21) Appl. No.: 14/832,340

(22) Filed: Aug. 21, 2015

Related U.S. Application Data
(60) Provisional application No. 62/040,235, filed on Aug. 21, 2014.

(51) Int. Cl. G06F 19/12; G01N 15/10

(52) U.S. Cl. CPC G06F 19/12; G01N 15/10; G01N 2015/1006

(57) ABSTRACT

Aspects of the present disclosure generally relate to methods for analyzing spatial trajectories of cells by identifying metrics corresponding to cell spatial properties and analyzing the metrics over time.

### CROSS-REFERENCE TO RELATED APPLICATION

This application claims benefit under 35 U.S.C. §119(c) of U.S. Provisional patent Application No. 62/040,235 filed Aug. 21, 2014, entitled “Characterizing Complex Biological Spatio-temporal Pattern Dynamics Using a Portable, Powerful, Pattern Recognition Pipeline,” which is incorporated herein by reference as if set forth herein in its entirety.

### STATEMENT REGARDING FEDERALLY SPONSORED RESEARCH

This invention was made with Government support under Grant Number DBET0939511, awarded by the National Science Foundation. The Government has certain rights in the invention.

### TECHNICAL FIELD

The present disclosure is in the technical field of bioinformatics. More particularly, the present disclosure relates to the field of computational modeling and analysis of biological systems.

### BACKGROUND

Model organisms, such as Zebrafish, C. Elegans, and Drosophila, are frequently used to understand complex sets of regulatory cues and gene regulatory networks governing morphogenic processes due to the technical ease in manipulating and imaging these systems. A complementary and alternative in vitro platform for probing mechanisms of development is pluripotent embryonic stem cell (ESC) aggregates. ESC aggregates can differentiate into tissues from all three germ layers which can result in the formation of a variety of tissues including optic cups, human intestinal lining and cerebral organoids. These multicellular systems are highly complex both in terms of the heterotypic cell types that comprise the tissue and the emergent spatiotemporal dynamics exhibited by the heterogeneous cell populations.

Computational modeling of embryonic development is a useful tool for generating multi-scale simulations of complex organismal systems. For example, computational models have been constructed to study cell signaling and lineage development in C. Elegans and Drosophila and provide new insight into the complex interplay of mechanisms governing development. Stage-specific models have also been created to examine other developmental phenomena, such as gastrulation and somite formation, on a mechanical level, while models to study the formation and differentiation of cells in the early mouse embryo and in mouse ESC aggregates study mechanisms governing cell fate at earlier time points. These modeling approaches have provided a wealth of quantitative data to describe spatio-temporal events associated with morphogenesis; however, it is extremely difficult to relate spatial modeling predictions directly with experimental outcomes due primarily to the difficulty in quantifying multicellular pattern features.

This challenge has hindered high-throughput analysis of developmental processes. In experimental systems, divergent phenotypes are often characterized largely by visual inspection, and thus lack the quantitative rigor and objective criteria necessary for direct comparison with computational models. Though several techniques exist to automatically distinguish phenotypes at various spatial scales, these techniques often lack the resolution of single-cell regulatory dynamics or are customized specifically for investigation of a single system. As a result, quantitative metrics extracted from such studies cannot be easily translated between different modes of data analysis or across various model organisms. Therefore, a portable pattern recognition pipeline capable of handling various biological and computational inputs would enable direct quantitative comparisons on previously unattainable spatial and temporal scales between different multicellular systems.

Aspects of the present disclosure will address these and other limitations.

### BRIEF SUMMARY OF THE DISCLOSURE

Briefly described, and according to some embodiments, aspects of the present disclosure generally relate to methods for analyzing multicellular spatial trajectories using metrics quantifying certain cell properties. These methods find use in addressing biologically relevant questions about cellular pattern formation across various morphogenic, multicellular systems.

In some embodiments a processor may receive data representative of a cellular aggregate image wherein the cellular aggregate image may represent a plurality of individual cells. The processor may then identify cell image data associated with each cell of the plurality of individual cells. Then, the processor may construct a network representation associated with the cellular aggregate image. From the network representation, the processor may identify one or more metrics corresponding to a first cell spatial property. The one or more metrics, and their effects or relationship with cell spatial trajectories, may be analyzed by determining a correlation between the metrics and a period of time. This correlation may be visualized by outputting, for display, data representative of a plot demonstrating the correlation between the one or metrics and the period of time.

These and other aspects, features, and benefits will become apparent from the following detailed written description of the exemplary embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure, and, together with the written description, serve to explain the principles of the disclosure.

FIG. 1 is a flow diagram illustrating a method for analyzing spatial trajectories, according to some embodiments.

FIG. 2 is a flow diagram illustrating a method for reconstructing an image into a network representation, according to some embodiments.

FIG. 3 is a flow chart with images illustrating a network digitization process for a cellular aggregate image taken using histology, according to some embodiments.

FIG. 4 is a flow chart with images illustrating a network digitization process for a cellular aggregate image of 3D confocal Cichlid embryonic cells, according to some embodiments.

FIG. 5 is a flow chart with images illustrating a general summary of the methods for analyzing spatial trajectories, according to an example embodiment.

FIG. 6 is a diagram of an illustrative computer system architecture, according to an example embodiment.

FIGS. 7A and 7B are graphical representations of an experimental validation of spatial network metrics for pattern classification, according to an example embodiment.

FIGS. 8A and 8B are a heat map showing clustering metrics for each clustering algorithm and a heat map showing classification metrics for each classification algorithm respectively, according to an example embodiment.

FIG. 9 shows various PCA plots of different classification schemes, according to an example embodiment where colors indicate the different class of pattern assigned to the given data point.

FIG. 10A-10E demonstrate various modes of analysis of sliced 2D networks, according to some embodiments.

FIG. 11A-11F contain various figures evaluating the spatial and temporal patterns during early ESC aggregate differentiation, according to an example embodiment.

FIG. 12 contains two PCA plots, one for a 250 cell/aggregate and one for 1000 cell/aggregate demonstrating a trajectory over time, according to an example embodiment.

FIG. 13A-13F provide a characterization of computational pattern trajectories and comparison to experimental patterns, according to an example embodiment.

FIG. 14A-14F demonstrate network metrics being used for novel classification techniques and subsequent evaluation of spatial patterns of late embryonic differentiation, according to an example embodiment.

FIG. 15 demonstrates shows a comparison of MP, D7 BMP4, and MP+Inhibition and prevailing morphological trajectories, according to an example embodiment.

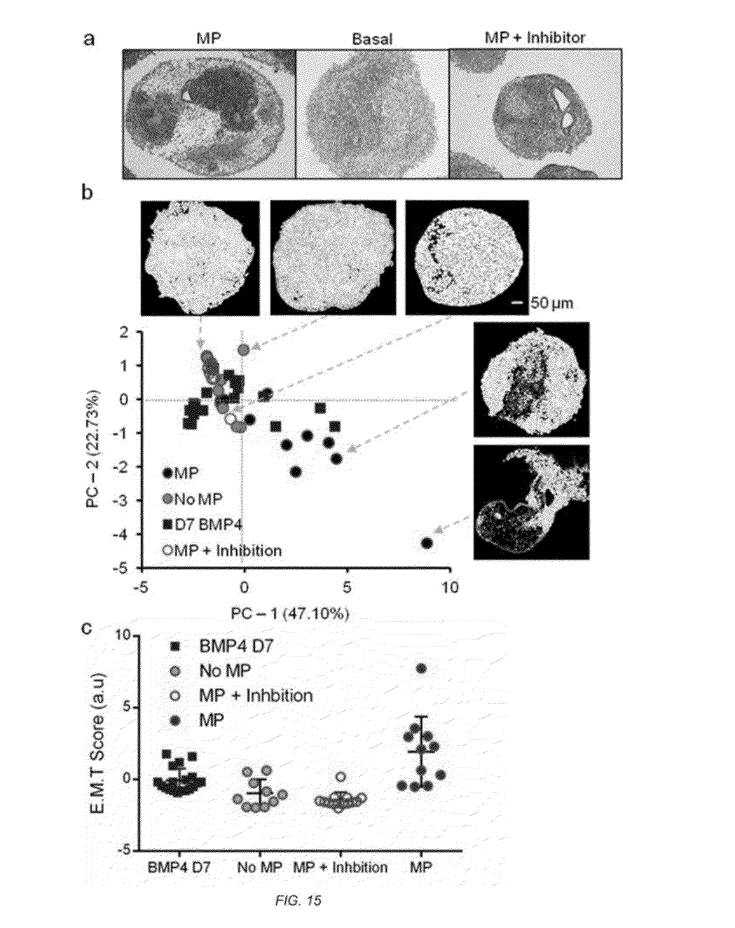

FIG. 16 shows image annotation to train classifiers to identify mesenchymal phenotypes, according to an example embodiment. The annotated images were subsequently converted to masked images for use in the training data set. Scale bars are the same on all images (set to 50 μms).

FIG. 17A-17E show various comparisons between different classification methods for recognizing mesenchymal regions, according to an example embodiment.

FIG. 18 demonstrates how network-based properties correlate with mesenchymal phenotype, according to an example embodiment.

FIG. 19A-19E reveals the importance of the transition from a pSmad+ dominated early gastrulation phase to dlx3b+ crescent formation in late stage gastrulation, according to an example embodiment.

FIG. 20A-20C show how information analysis can predict evolution of images during gastrulation, according to an example embodiment.

### DETAILED DESCRIPTION

Described herein are methods for analyzing multicellular pattern trajectories using network-based metrics. Through these methods, cell patterns can be detected and analyzed using a combination of image processing and network reconstruction. Image processing techniques enable a processor to detect and identify individual cells. From these cells, the processor can draw connections between cells or a cluster of cells to create a network. The resulting network can then be used to identify metrics corresponding to individual cell spatial properties and how cells relate to one another. The interplay between network reconstruction and metric extraction permits meaningful quantitative analysis of any complex, multicellular system at a single-cell level.

Network and information theory provide a powerful tool for the analysis of many complex systems ranging from social to biological networks. For the first time, the methods disclosed apply the principles of network theory to analyze spatial trajectories of morphogenic biological systems. Increasingly, examples of emergent spatial patterns are being reported from initial pluripotent states, leading to organoids such as optic cups, cerebral tissues, or others; however, quantitative descriptions of multicellular patterns were still lacking. For example, Warmflash et al. recently used radial distance to delineate organization of differentiated phenotypes within micropatterned ESC colonies, while Herberg et al. used a similar method to compare spatial distributions of proteins in ESC colonies to computational models. Due to the complexity of many multicellular systems, however, known imaging techniques and computational models cannot analyze spatial patterns at an individual-cell level. Additionally, these approaches are not sufficient to describe more complex 3D structures.

Some embodiments of the present invention can reconstruct cellular locations as interacting networks capable of subsequent subdivision into biologically relevant sub-networks. This network-based approach may circumvent problems associated with traditional classification methods that rely solely on standardized images and use of individual pixel classification methodologies. Known approaches require specifically-orientated and annotated images, are limited to the organism of interest, and/or often do not have single-cell resolution. In particular, machine learning algorithms developed for positional dependence of patterning in Drosophila have not relied on individual-cell segmentation for evolution of network connectivity over time.

Embodiments of the present invention may offer a portable, transparent and universal pattern classification technique capable of handling various biological and computational inputs and enabling direct quantitative comparisons between different systems or models. More specifically, the methods disclosed can detect subtleties of spatial phenotypes through the use of spatially-derived networks and subsequent analysis via network theory. These methods may involve extracting global metrics, such as cell path lengths and cell connectivity information, as well as local metrics based on specific clusters of cell phenotypes. These methods may also comprise identifying property-driven sub-networks, allowing for further network quantification by extracting specific sub-population information. The multiple examples illustrated herein highlight the broad utility of network-based analysis for identification of spatial biological patterns via the formulation of novel pattern metrics.

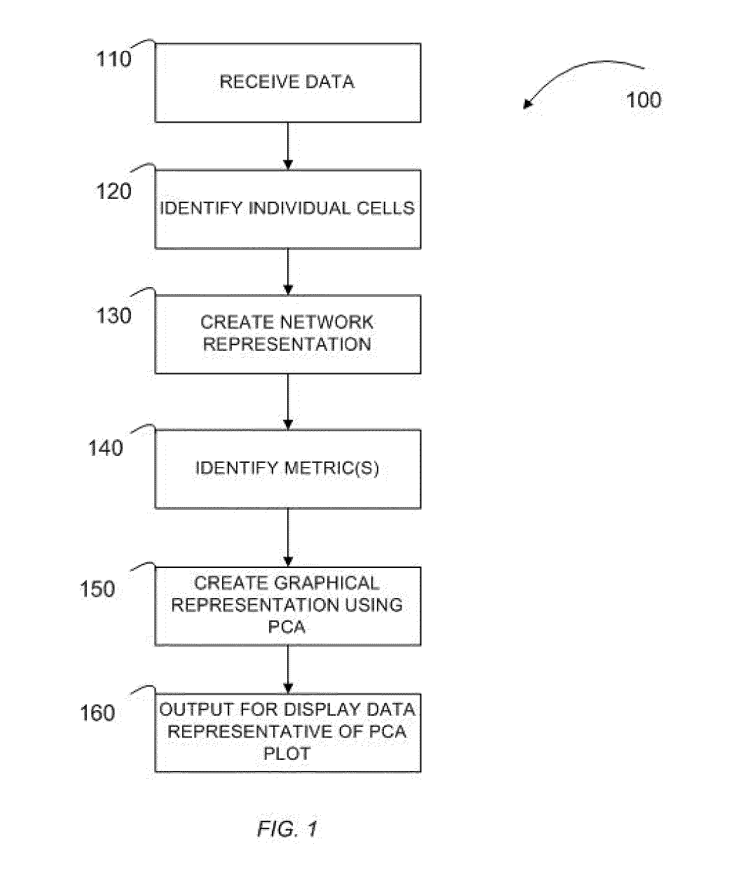

Turning now to the drawings, in which like reference characters indicate corresponding elements, attention is directed to FIG. 1 in which a flow diagram illustrates an exemplary method comprising various steps by which metrics of morphogenic cell patterns can be quantitatively analyzed. As shown at FIG. 1, a processor may receive data representing a cellular aggregate 110. One benefit of some of the methods disclosed is their applicability across various biological and computational inputs. Therefore, the processor may receive various input data types.

In some embodiments, the processor may receive data representative of a cellular aggregate image. As used herein, “cellular aggregate” may refer to any multicellular group, collective, system, mass, or body. Therefore, a cellular aggregate image may represent a plurality of individual cells. For example, the cellular aggregate may be one or more embryoid bodies (EBs), wherein undifferentiated ESCs are maintained in a suspension culture as described by White, et al. Each EB may comprise a plurality of undifferentiated ESCs. “Cellular aggregate” may also include an artificial representation of cells where individual cells are modeled using physics-based modeling. For example, the cells may be modeled as incompressible rigid spheres, ellipsoids, or circles as described by White, et al. Moreover, the cells may be modeled or imaged in 2D or 3D. Applicants expressly incorporate by reference the disclosure by White, et al. White D E, Kinney M A, McDevitt T C, Kemp M L (2013) Spatial pattern dynamics of 3d stem cell loss of pluripotency via rules-based computational modeling. PLoS Comput Biol 9: e1002952.

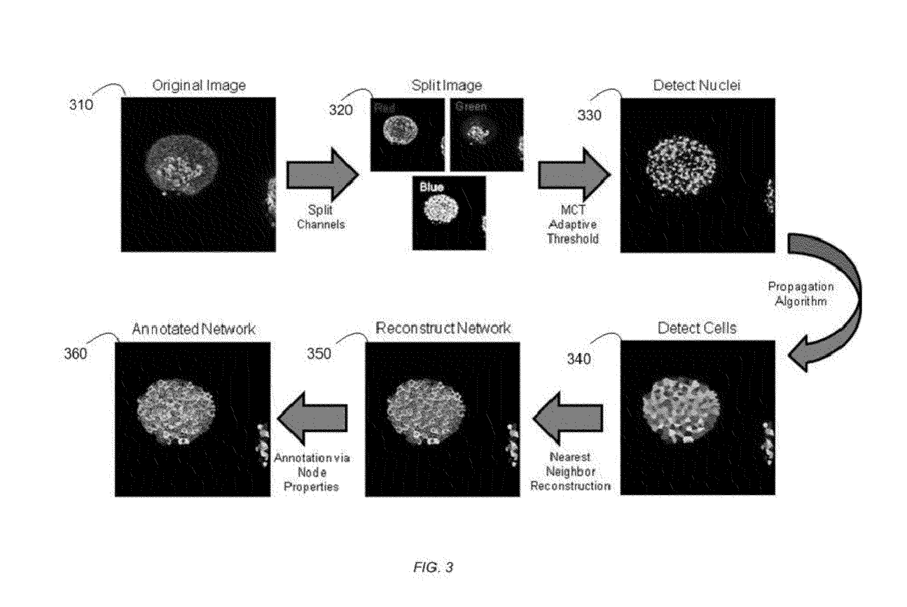

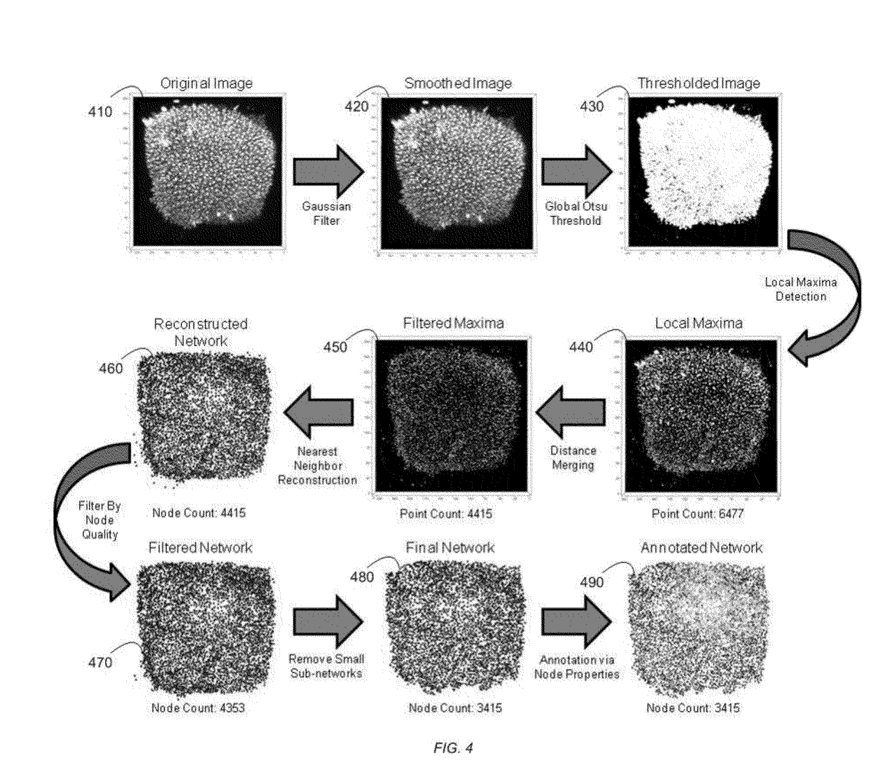

In an example embodiment, the cellular aggregate image may be acquired experimentally. For example, the images may be in vitro images of cell cultures, as shown at 310 and 410 of FIGS. 3 and 4. In some embodiments, an image may be an in silico model of a cellular aggregate. The in silico model may use incompressible spheres or ellipsoids to model individual cells. The cells may be arranged according to patterns observed in a biological context. The patterns may be generated by using one or more pattern generation algorithms configured to arrange the incompressible spheres according to cell pattern types observed experimentally. In other embodiments, the data may include numerical data or data contained within a data field wherein the data corresponds to various cellular properties. For example, the processor may receive data corresponding to various cell locations in a space.

Another benefit of the methods disclosed, is the ability to compare experimental data with model data. In such embodiments, experimental data and in silico data may be merged. Following, the data received by the processor 110 may comprise a combination of experimental data representative of a cellular aggregate image and in silico data obtained from the in silico model merged into a data set.

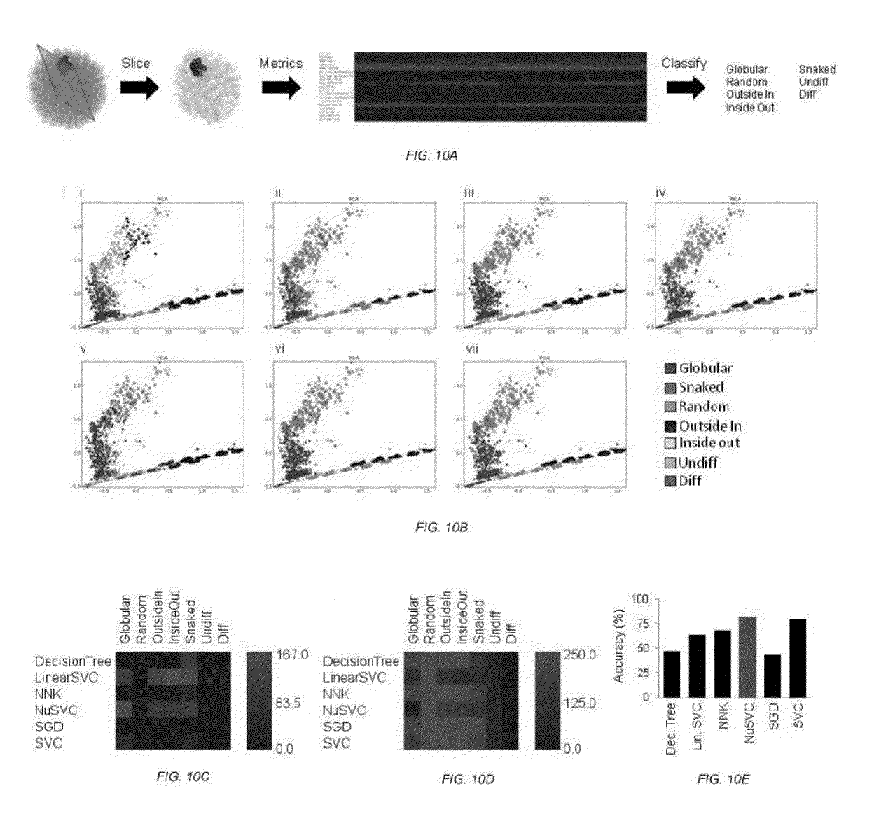

The methods disclosed may be applicable across various cell-types, cellular aggregate sizes, and imaging dimensions. It is understood that the various embodiments of the present invention are applicable to many cell types over various species. The cellular aggregates may be of various aggregate densities wherein the cell density may correspond to a cell count in a specific culture. It is understood that the methods disclosed may apply to images of various cell densities (e.g. 50, 100, 200, 250, 500, 1000 cells/aggregate). In some embodiments, the aggregate densities may exceed 1000 cells/aggregate. Additionally, according to some embodiments, an image may contain more than one cellular aggregate. Therefore, the images may be split into several different images, each containing a single cellular aggregate. The images may be in 3D, as shown at 410 of FIG. 4. In some embodiments, the image is of a 2D aggregates, as shown at 310 of FIG. 3. In other embodiments, the image may represent a slice of 3D image, as shown at FIG. 10A.

The methods may apply to images taken with various imaging techniques. In some embodiments, the experimentally-derived images may be taken using confocal microscopy. In other embodiments, the experimentally-derived images may be histological images, as shown at 310 of FIG. 3. Histological images may include images of cells that are fixed, stained with a marker, and analyzed using a either a light or electron microscope. In some embodiments, the experimentally-derived images may be acquired using other types of microscopy such as multi-channel microscopy, electron microscopy, or optical microscopy.

In some embodiments, as shown in FIG. 1 at 130, the processor can convert the data into a network representation. As used herein, a network representation may mean any reconstruction or conversion of image data into an in silico model. In an embodiment, the network representation may comprise a series of nodes corresponding to each individual cell of the aggregate, as shown at 420 of FIG. 4, with various connections between nodes located within a certain distance.

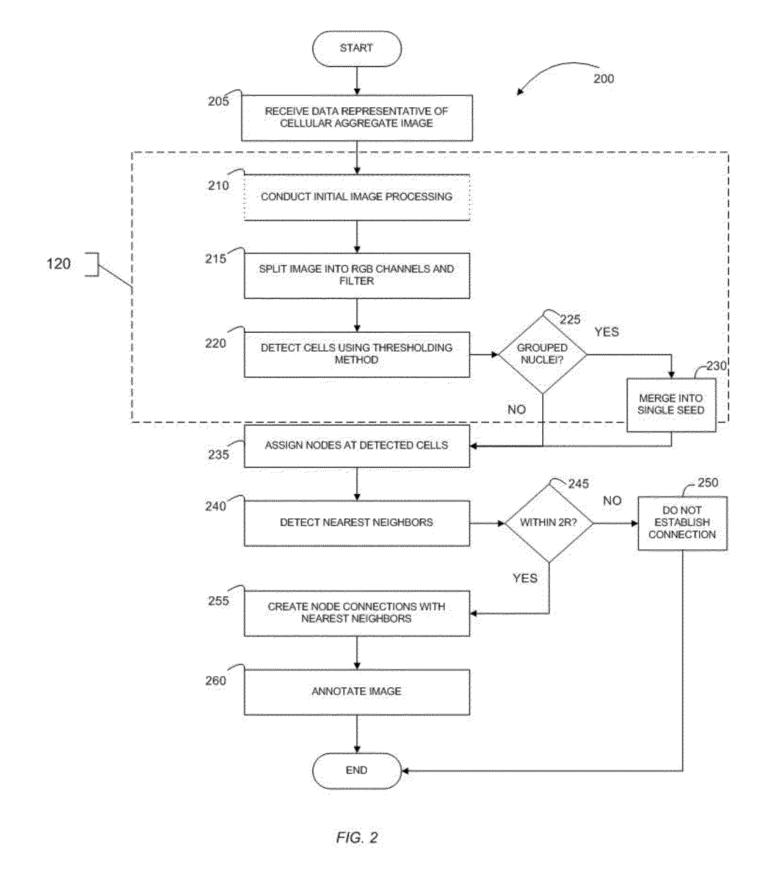

FIG. 2 demonstrates an exemplary embodiment wherein the network representation may be created using a network reconstruction pipeline. The pipeline 200 may comprise many steps accomplished using known methods and Open Source software. The pipeline 200 may receive data representative of a cellular aggregate image 205. The cellular aggregate image can encompass any and all of the embodiments discussed above. Optionally, the processor may apply preliminary image processing techniques 210 to begin detecting individual cells 120. Initial image processing may be conducted using various suitable tools including certain Open Source software, such as Cell Profiler, or using scientific software such as IMARIS. Such image processing techniques may include but are not limited to initial filtering, such as applying a Guassian Filter, splitting images into various channels, merging images, or converting various images into a memory-mapped array. In an embodiment, an image may be split into different channels. Those channels may correspond to a red-green-blue (RGB) color space 215.

Individual cells may be detected 120 by applying a thresholding method 220. Available thresholding methods may include the global Otsu approach that can generate a binary mask. The binary mask may demonstrate where cell bodies are located, for example. In other embodiments, the MCT Adaptive Thresholding technique may be used to locate the nuclei of individual cells. From the nuclei, secondary bodies, such as the cell membranes or cell cytoplasm which may delineate the outer boundaries of cells, may be determined to identify entire cells. In some embodiments, when locating individual cells, grouped cells or nuclei 225 may be resolved by merging nuclei 230 that are too close together.

A network representation may be constructed by assigning nodes 235 representing individual cells or nuclei and creating node connections 255. “Node” as used herein can mean a connection point, a redistribution point, or a communication start point or endpoint. “Node connections” or “connectors” as used herein can mean a medium over which information can be extracted, communicated, or received. As used herein “network representation” can be defined as a series of nodes and connectors associated with a cellular aggregate image.

Network reconstruction may be accomplished using a nearest neighbor analysis, according to some embodiments. The nearest neighbor analysis and detection 240 may be implemented using Open Source Python script, including scipy and the KDTree implementation. In some embodiments, the nearest neighbor analysis may detect one or more nodes of closest proximity to another node. In instances where an identified nearest neighbor is too far away, such as where the nearest neighbor is not within the same cluster or within a certain distance from a cell 245, then the processor may be instructed not to establish a network connection between those neighbors 250. In some embodiments, the network may be created separately from the image. In other embodiments, the network may overlay the cellular aggregate image, as seen at 350 of FIG. 3.

As shown in FIG. 2, the processor may annotate the image 260. When annotating the image, the processor may assign “tags” to the individual nodes corresponding to certain object properties. These properties may relate to certain metrics of interest or designate that the objects may acquire or maintain one or more properties. These “tags” may then be used to extract relevant metrics about the image. For example, in the context of ESCs, individual cells may be tagged as Oct4+ or Oct4− depending on the properties of the measured image.

As shown in FIG. 1, the processor may identify or determine certain metrics corresponding to cell properties 140. In some embodiments, the metrics may be identified using the network representation, wherein the processor may compute metrics about relationships between the nodes of the network. These metrics may include, for example, distance between nodes, a node count, the number of nodes having a certain cell phenotype, and respective average and standard deviation measurements. In other embodiment, the processor may compute metrics related to groupings or clusters of cells sharing similar properties, where a grouping is defined as cells which are connected within the network. These metrics may include, for example, the size of a cluster, the number of cells in a cluster, the number of clusters, the relationship between clusters and the number of cells in a cluster having a particular phenotype. In other embodiments, the metrics may be determined by image processing prior to constructing the network. For example, the processor, by image processing techniques may identify cells with certain protein expression by analyzing the color of the cells.

In other embodiments, the metrics may be predetermined using a model. For example, an artificially trained network can be created by using one or more pattern generation algorithms to simulate spatial features of differentiation in 3D multicellular aggregates, as demonstrated by White, et al. The artificially trained network may comprise data corresponding to cellular patterns determined from simulating cell patterns examined experimentally.

The metrics obtained from the network representation may correspond to global or local properties. As used herein “global” metrics may include metrics describing the network as a whole. Global metrics may include path lengths, average connection counts, connection lengths, and node counts. In some embodiments, the large network of cells may be divided into one or more sub-networks. “Local” metrics may correspond to metrics describing each sub-network. Local metrics may include number, size, and distribution of the relevant sub-networks.

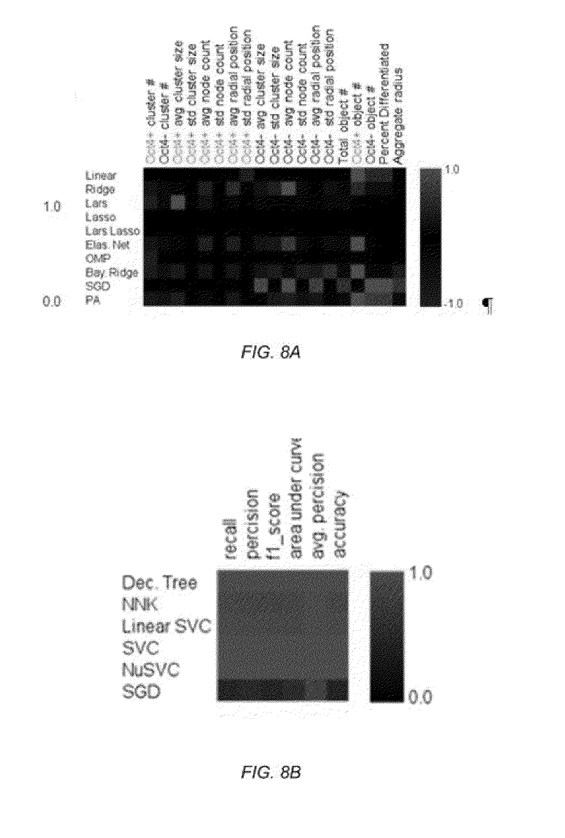

In some embodiments, the processor may reconstruct the network into various sub-networks corresponding to certain shared characteristics. For example, the network may be split into sub-networks corresponding to cell phenotype, as shown at FIG. 8C. In an example embodiment examining ESC differentiation, two sub-networks may be examined: Oct4 positive (Oct4+) or Oct4 negative (Oct4−) (as sheen at FIG. 8C). In FIG. 8C, Oct4+ cells are represented in teal and Oct4− cells are represented in blue. In that embodiment, a sample of ESCs may be stained with an anti-body corresponding to a protein expressed in undifferentiated cells, such as Oct4. As cells differentiate, fewer cells may express that protein. Therefore, the stain may be detected during image processing of the image of undifferentiated cells and not detected during image processing of an image of differentiated cells. In some embodiments, where cell staining is used to “color” certain cells of a specific phenotype, an intensity function may be used to detect cells, and a signal corresponding to a certain color may be read to indicate a cell of a specific phenotype.

In some embodiments, cells may be split up based on an association with or without a cluster of other cells. For example, sells may be divided into sub-networks based on cell phenotype. Clustering may also be conducted using processing algorithms. These algorithms may include algorithms available in the sklearn distribution from Python, such as K-means, Ward Hierarchical, BDSCAN, Mean-Shift, and Affinity Propagation. Once cells are split into clusters or sub-networks, local metrics may be extracted about the individual clusters, such as connection count, cluster shape, or cell count.

As shown at FIG. 1, principal component analysis (PCA) may be conducted to analyze the extracted metrics 150, and the processor may output for display data representative of a PCA plot 160. PCA allows for visualization of a high-dimensional data set via a dimension reduction technique. By projecting data onto a plane which preserves the most variance, a resulting variance-maximized projection can be created. As may be applied in the disclosed methods, PCA can be used in both of these circumstances: as a decomposition tool for visualization of a high dimensional data set, and also as a model to help describe how measurements contribute to the observed trajectories.

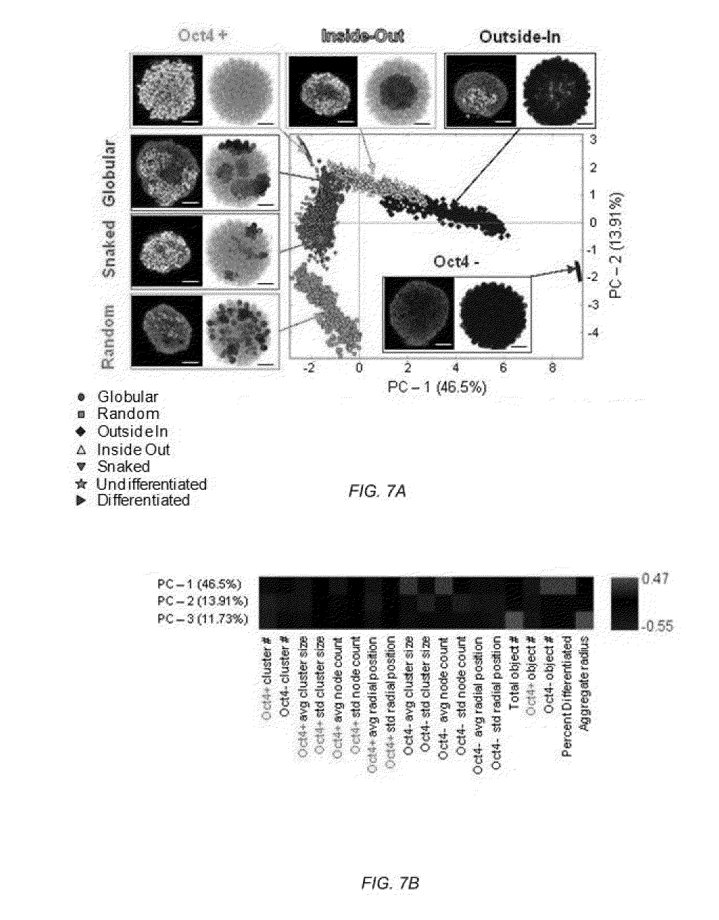

In an exemplary embodiment, PCA may be used to determine if network-derived metrics adequately describe differences in spatial patterns. Using PCA, one or more plots may be created to visualize the effects of the metrics on pattern evolution, as seen, for example, at FIG. 7B. PCA may also be used to map different patterns with respect to time or provide an overall trajectory of the images. For example, in the context of ESC differentiation, a first principal component may represent the overall stage of differentiation and demonstrate correlation with variables associated with differentiated clusters. A second and third principal component may represent spatial sub-network descriptors, such as Oct4+ and Oct4−. In some embodiments, a 2D plot of the samples may be generated. In other embodiments, the plot may be generated in 3D. Various numbers of components may be used depending on the data or image and the metrics that are extracted from the data or image.

A PCA plot corresponding to cell spatial patterns over time may reflect network reconstruction and analysis of more than one image. In an exemplary embodiment, various images may be obtained from in vitro imaging of cellular aggregates at different time points. These images may represent “frames” of cell movement or patterns over time. After network reconstruction of the images and metric extraction, a PCA plot may be created representing the trajectory of cell spatial patterns throughout time. The processor may then run a PCA program and output data representative of a PCA plot over time.

Additionally, Regression techniques and classification algorithms may be used to analyze the extracted metrics. State vector machines (SVM) and other clustering methods are proven automated approaches for examining data based on extracted metrics. Classification techniques depend heavily on the extracted metrics; with spatial patterns, extraction of meaningful metrics in the prior art has proved especially difficult, as information on the phenotypes and their respective spatial relationships must be preserved. Using the methods described above, however, network-based metrics at a single-cell level may be obtained that permit meaningful analysis using SVMs and PCA.

In some embodiments, classification methods may be used to analyze metric data extracted from network representations of cellular aggregates. Such methods may include logistic regression, k nearest neighbor (KNN), state vector machines (SVM, NuSVC), stochastic gradient descent (SGD), and decision tree algorithms. Additionally, these regressions may be used across various applications, including 2D, networks, 3D networks, 2D confocal images, and histological images. Moreover, regression models may be evaluated across a myriad of different approaches: linear, ridge, lasso, elastic net, least angle (LARs), LARs lasso, orthogonal matching pursuit (OMP), Bayesian, Bayesian ridge, Logistic, Stochastic Gradient Descent (SGD).

FIG. 3 shows an example network reconstruction method for a histological image of a cellular aggregate that is similar or incorporated within the method shown in FIG. 2. As opposed to the method in FIG. 2, FIG. 3 demonstrates an application-specific use of the network reconstruction pipeline in a histological context where the process of splitting images 120 includes splitting the histological image into respective channels 320. Individual cell detection may be performed in Cell Profiler, while the subsequent steps may be performed using Python. For example, an MCT Adaptive Threshold, from Cell Profiler, may be used to detect nuclei 330 of individual cells. A propagation algorithm, from Cell Profiler, which may include an algorithm to detect secondary bodies such as cytoplasm or cell membranes, can be employed to identify individual cells 340. After the initial image procession, the processor can reconstruct a network can using a nearest neighbor reconstruction 350 and annotation 360 via node properties using Python programs. In the case of histological images, this pipeline and the metrics extracted allow for a more precise and direct analysis of histological images and are useful in detecting cell phenotypes and spatial descriptors.

FIG. 4 shows an example network reconstruction method for a 3D confocal image that is also similar to the method described in FIG. 2. Additional image processing for the 3D image includes the application of a Gaussian Filter to smooth the image 420. FIG. 4 also provides an example in which nuclei that are too close together are “distance merged” 440 to create new local maxima 450. Subsequent filtering may also be conducted downstream to determine node quality 470 and remove small sub-networks 480 (such as individual cells).

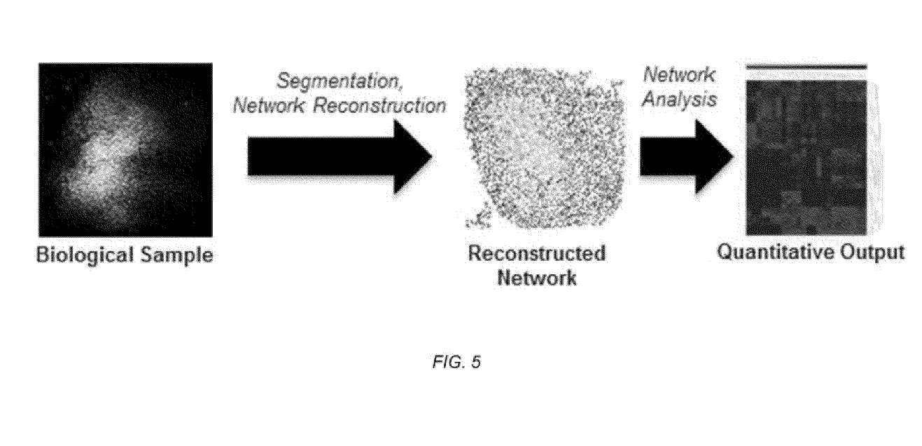

FIG. 5 demonstrates an example representation of the overall process described herein. FIG. 5 shows the flow from a biological sample, to a reconstructed network via network reconstruction, and analysis of the reconstructed network to a final quantitative output, such as a heat map.

In some aspects, the method can be executed by a computing device configured to perform the one or more steps of a given method. Moreover, in an embodiment, the methods can have one or more graphical user interfaces (GUI). In another embodiment, the methods may be embedded in a website.

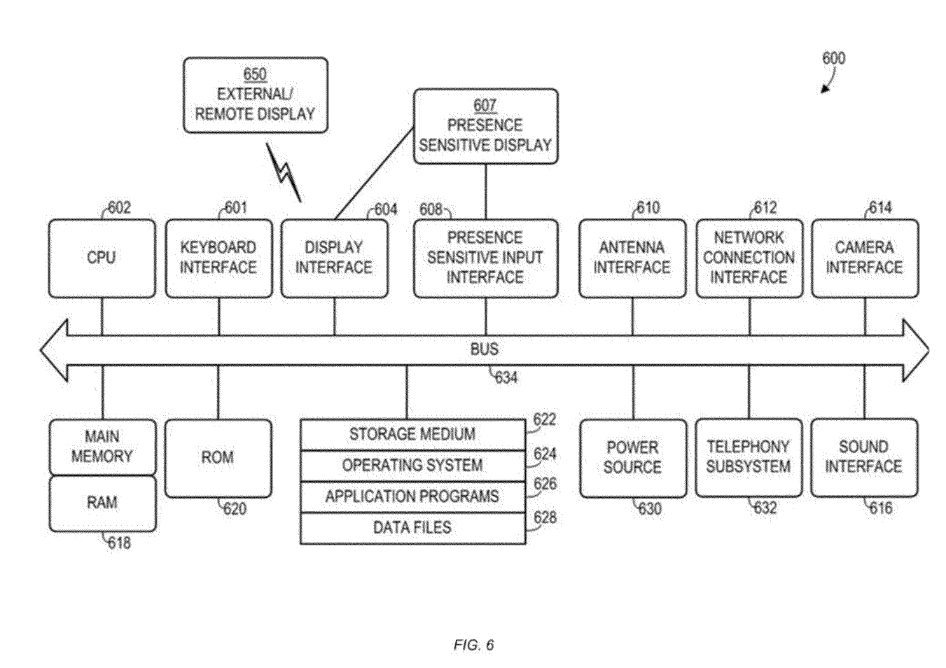

As desired, implementations of the disclosed technology may include a computing device with more or less of the components illustrated in FIG. 6. It will be understood that the computing device architecture 600 is provided for example purposes only and does not limit the scope of the various implementations of the present disclosed systems, methods, and computer-readable mediums.

The computing device architecture 600 of FIG. 6 includes a central processing unit (CPU) 602, where computer instructions are processed; a display interface 604 that acts as a communication interface and provides functions for rendering video, graphics, images, and texts on the display. In certain example implementations of the disclosed technology, the display interface 604 may be directly connected to a local display, such as a touch-screen display associated with a mobile computing device. In another example implementation, the display interface 604 may be configured for providing data, images, and other information for an external/remote display that is not necessarily physically connected to the mobile computing device. For example, a desktop monitor may be utilized for mirroring graphics and other information that is presented on a mobile computing device. In certain example implementations, the display interface 604 may wirelessly communicate, for example, via a Wi-Fi channel or other available network connection interface 612 to the external/remote display.

In an example implementation, the network connection interface 612 may be configured as a communication interface and may provide functions for rendering video, graphics, images, text, other information, or any combination thereof on the display. In one example, a communication interface may include a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof. In one example, the display interface 604 may be operatively coupled to a local display, such as a touch-screen display associated with a mobile device. In another example, the display interface 604 may be configured to provide video, graphics, images, text, other information, or any combination thereof for an external/remote display that is not necessarily connected to the mobile computing device. In one example, a desktop monitor may be utilized for mirroring or extending graphical information that may be presented on a mobile device. In another example, the display interface 604 may wirelessly communicate, for example, via the network connection interface 612 such as a Wi-Fi transceiver to the external/remote display.

The computing device architecture 600 may include a keyboard interface 606 that provides a communication interface to a keyboard. In one example implementation, the computing device architecture 600 may include a presence-sensitive display interface 608 for connecting to a presence-sensitive display 607. According to certain example implementations of the disclosed technology, the presence-sensitive display interface 608 may provide a communication interface to various devices such as a pointing device, a touch screen, a depth camera, etc. which may or may not be associated with a display.

The computing device architecture 600 may be configured to use an input device via one or more of input/output interfaces (for example, the keyboard interface 606, the display interface 604, the presence sensitive display interface 608, network connection interface 612, camera interface 614, sound interface 616, etc.,) to allow a user to capture information into the computing device architecture 600. The input device may include a mouse, a trackball, a directional pad, a track pad, a touch-verified track pad, a presence-sensitive track pad, a presence-sensitive display, a scroll wheel, a digital camera, a digital video camera, a web camera, a microphone, a sensor, a smartcard, and the like. Additionally, the input device may be integrated with the computing device architecture 600 or may be a separate device. For example, the input device may be an accelerometer, a magnetometer, a digital camera, a microphone, and an optical sensor.

Example implementations of the computing device architecture 600 may include an antenna interface 610 that provides a communication interface to an antenna; a network connection interface 612 that provides a communication interface to a network. As mentioned above, the display interface 604 may be in communication with the network connection interface 612, for example, to provide information for display on a remote display that is not directly connected or attached to the system. In certain implementations, a camera interface 614 is provided that acts as a communication interface and provides functions for capturing digital images from a camera. In certain implementations, a sound interface 616 is provided as a communication interface for converting sound into electrical signals using a microphone and for converting electrical signals into sound using a speaker. According to example implementations, a random access memory (RAM) 618 is provided, where computer instructions and data may be stored in a volatile memory device for processing by the CPU 602.

According to an example implementation, the computing device architecture 100 includes a read-only memory (ROM) 620 where invariant low-level system code or data for basic system functions such as basic input and output (I/O), startup, or reception of keystrokes from a keyboard are stored in a non-volatile memory device. According to an example implementation, the computing device architecture 600 includes a storage medium 622 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 624, application programs 626 (including, for example, a web browser application, a widget or gadget engine, and or other applications, as necessary) and data files 628 are stored. According to an example implementation, the computing device architecture 600 includes a power source 630 that provides an appropriate alternating current (AC) or direct current (DC) to power components. According to an example implementation, the computing device architecture 600 includes a telephony subsystem 632 that allows the device 600 to transmit and receive sound over a telephone network. The constituent devices and the CPU 602 communicate with each other over a bus 634.

According to an example implementation, the CPU 602 has appropriate structure to be a computer processor. In one arrangement, the CPU 602 may include more than one processing unit. The RAM 618 interfaces with the computer bus 634 to provide quick RAM storage to the CPU 602 during the execution of software programs such as the operating system application programs, and device drivers. More specifically, the CPU 602 loads computer-executable process steps from the storage medium 622 or other media into a field of the RAM 618 in order to execute software programs. Data may be stored in the RAM 618, where the data may be accessed by the computer CPU 602 during execution. In one example configuration, the device architecture 600 includes at least 128 MB of RAM, and 256 MB of flash memory.

The storage medium 622 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow a computing device to access computer-executable process steps, application programs and the like, stored on removable and non-removable memory media, to off-load data from the device or to upload data onto the device. A computer program product, such as one utilizing a communication system may be tangibly embodied in storage medium 622, which may comprise a machine-readable storage medium.

According to one example implementation, the term computing device, as used herein, may be a CPU, or conceptualized as a CPU (for example, the CPU 602 of FIG. 1). In this example implementation, the computing device (CPU) may be coupled, connected, and/or in communication with one or more peripheral devices, such as display. In another example implementation, the term computing device, as used herein, may refer to a mobile computing device such as a smartphone, tablet computer, or smart watch. In this example implementation, the computing device may output content to its local display and/or speaker(s). In another example implementation, the computing device may output content to an external display device (e.g., over Wi-Fi) such as a TV or an external computing system.

In example implementations of the disclosed technology, a computing device may include any number of hardware and/or software applications that are executed to facilitate any of the operations. In example implementations, one or more I/O interfaces may facilitate communication between the computing device and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the computing device. The one or more I/O interfaces may be utilized to receive or collect data and/or user instructions from a wide variety of input devices. Received data may be processed by one or more computer processors as desired in various implementations of the disclosed technology and/or stored in one or more memory devices.

One or more network interfaces may facilitate connection of the computing device inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth enabled network, a Wi-Fi enabled network, a satellite-based network any wired network, any wireless network, etc., for communication with external devices and/or systems.

### EXAMPLES

### Example 1

### A. Identification of Network-Based Metrics

To identify appropriate metrics for characterizing spatial patterns, a flexible and expedient computational framework was used to generate a large, in silico training set comprised of various types of multicellular patterns. This in silico data was generated using seven different pattern generation algorithms to simulate spatial features of differentiation in 3D multicellular aggregates: Undifferentiated, Differentiated, Inside-Out, Outside-In, Random, Globular, and Snaked as shown at FIG. 7A. These pattern generation algorithms are described by White et al. incorporated by reference above. White, et al. modeled EBs as incompressible rigid spheres to test how the proposed algorithms impacted pattern generation in a model. It is also known in the art that cell bodies can be modeled as other incompressible objects such as ellipsoids. The various patterns of ESCs going from an undifferentiated state to a differentiated state corresponded to monitoring of ESCs in culture for multiple days and visually classifying the observed spatial trajectories.

Following, the differentiated patterns for the in silico data were created by assigning a differentiated state to 95% of the cells. The undifferentiated states were created by assigning an undifferentiated state to 95% of the cells. The 5% margin was incorporated to account for some of the error occurring during network reconstruction of biological data using a network digitalization algorithm, as discussed below. FIG. 7A provides images of each of the patterns comparing biologically observed patterns with in silico generated to demonstrate the fidelity of pattern generation in silico.

Outside-In patterns were generated by setting a radius parameter such that all cells inside a certain radius were set to undifferentiated, while all cells outside the radius were set to differentiated. Inside-Out patterns were generated by setting a radius parameter where all cells inside a certain radius were set to differentiated, while all cells outside the radius were set to undifferentiated. Random patterns were generated by randomly setting a fraction of the cells to a differentiated state. Globular patterns were created using two parameters: a seed number and an expansion number. The seed number governed how many differentiated cell clusters would be found initially, and the expansion parameter governed how many layers of nearest neighbors would be turned into a differentiated state. For example, an expansion parameter of two would turn all cells within two network connections away to a differentiated state. Snaked parameters were generated using two parameters: the number of seeds and the elongation of each seed. The number of seeds again denoted the number of initial starting locations that were differentiated. Each of these conditions extended to a length of n, where length n designates the distance from a cellular body through which random neighbors are turned to a differentiated state.

Computational modeling was carried out using a previously established framework with some slight modifications. A KDTree implementation as provided in the scipy.spatial package for Python was used for detecting and resolving collisions. The form of the rule functions was changed from previous work into a more classical activation and deactivation function:

$$\begin{matrix}P ( x ) = α & Equation 1 \text{:} Random Feedback \\ P ( x ) = \frac{k * {norm\_d}^{n\_p}}{k {1}^{n\_p} * {norm\_d}^{n\_p}} , \\ {norm}_{d} = \frac{d}{ε} & Equation 2 \text{:} Positive Feedback \\ P ( x ) = \frac{k 2}{k 3 + {( \frac{norm\_u}{k 4} )}^{n\_n}} , \\ {norm}_{u} = \frac{u}{ɛ} & Equation 3 \text{:} Negative Feedback \\ P ( x ) = \frac{k}{k 2 + {( \frac{norm\_u}{k 3} )}^{n\_n}} or \\ \frac{k * {norm\_d}^{n\_p}}{k {2}^{n\_p} * {norm\_d}^{n\_p}} & Equation 4 \text{:} Combined Feedback\end{matrix}$$

Where α=0.0025, c denotes the number of neighbors, k=1, k1=0.5, n_p=7, n_n=14, k2=1, k3=1, and k4=0.5. These values were determined using by hand fitting of individual parameters until differentiation trajectories which roughly matched the time scales of experimental differentiation were observed. As previously described the random differentiation coefficient was kept in all subsequent simulations, but for the random rule by itself a was set to 0.0075. These rules were considered to be satisfied if a randomly generated value was less than the calculated probability.

### B. Analysis of Network-Based Metrics

1. PCA

To examine the overall shape of the multi-dimensional data set, a dimensional reduction technique, PCA was performed to visualize data and output a PCA plot, as seen at FIG. 7A. PCA was performed using the sklearn package for the Python programming language. The Open Source Python package Matplotlib was used to plot and generate all PCA plots, while the heatmaps displaying component information were generated using custom code written using a combination of the Python packages numpy and PIL. Using the scale function from sklearn, all data points were mean-centered and unit variance scaled as required by the PCA algorithm. The PCA algorithm used relies on singular value decomposition, which can lead to multiple fitted estimators displaying the data with principal components flipped. When automatic dimension fitting is required, the PCA was interpreted as a density estimation and Bayesian model selection was used to determine the dimensionality of the data.

PCA generated a 2D projection of all samples based upon network features. The data was divided up into three principal components (PCs). PC-1 represented the stage of differentiation and was positively correlated with variables associated with differentiated clusters or overall differentiation; whereas, PC-2 and PC-3 were associated with spatial sub-network descriptors. FIG. 7A shows a PCA plot with representative images mapped on it that correspond to examples of experimental (green=Oct4 Antibody, blue=DAPI, red=phalloidin) and in silico generated pattern classes (teal=Oct4+, blue=Oct4−). Scale bars are 100 μm and 35 μm for the experimental and in silico images, respectively. Each representative image is color-coded according to pattern type. The scatter plot of FIG. 7A revealed some overlap between different pattern classes, particularly for the globular and snaked patterns. In general, however, the different classes could be readily distinguished. More importantly, a continuum of patterns was observed, suggesting a natural pattern evolution.

FIG. 7B shows a PCA axis analysis indicating the relative contribution of each metric to the given principal component axis. Overall, the model was able to explain 77.7% of the variance in the data set with three PCs: 46.5% with PC-1, 13.9% with PC-2 and 11.7% with PC-3 (FIG. 7B). This analysis demonstrated that each metric contributed significantly to the model, indicating that inclusion of all metrics provided a comprehensive description of the data set.

Examples of the binary metric definitions are listed below:

Oct4+_clust_#—the number of Oct4+ clusters (a cluster is defined as more than a single node)
Oct4+_size_avg—the average radius of the Oct4+ clusters
Oct4+_size_std—the standard deviation in the radius fo the Oct4+ clusters
Oct4+_nd_cnt_avg—the average number of nodes of the Oct4+ clusters
Oct4+_nd_cnt_std—the standard deviation in the number of nodes of the Oct4+ clusters
Oct4+_rad_dist_avg—the average radial distance of the Oct4+ clusters
Oct4+_rad_dist_std—the standard deviation of the radial distances of the Oct4+ clusters
Oct4−_clust_#—the number of Oct4− clusters (a cluster is defined as more than a single node)
Oct4−_size_avg—the average radius of the Oct4− clusters
Oct4−_size_std—the standard deviation in the radius of the Oct4− clusters
Oct4−_nd_cnt_avg—the average number of nodes of the Oct4− clusters
Oct4−_nd_cnt_std—the standard deviation in the number of nodes of the Oct4− clusters
Oct4−_rad_dist_avg—the average radial distance of the Oct4− clusters
Oct4−_rad_dist_std—the standard deviation of the radial distances of the Oct4− clusters
Total_obj_#—the total number of cells in the system
Object_#_{—} Oct4+—the total number of Oct4+ cells in the system
Object_#_{—} Oct4−—the total number of Oct4− cells in the system
Percent_diff—the total number of Oct4− cells/the total number of cells
Agg_radius—the maximal radius (size) of the aggregate as measured from the center

2. Classification, Clustering, and Regression Algorithms

To verify that simple, network-based metrics could describe complex spatial pattern classes, various classification, clustering, and regression algorithms were assessed to determine their ability to distinguish between pattern types. The clustering algorithms K-means, Ward Hierarchical, BDSCAN, Mean-Shift and Affinity Propagation were all used from the sklearn package. This code set up the grid searches which were then subsequently run and returned the best classifier. Each classifier was then evaluated using the following criterion: recall, precision, f1_score, area under the curve, average precision, and accuracy. Accuracy was computed as the fraction of completely accurate predictions. The average precision scores and the area under the curve are derived from the precision-recall curve, where the average precision is the average value over the curve, and the area is the integral of the entire curve. The precision score measures the ability of the classifier to not label as positive a sample which is negative. The recall score is the ability of the classifier to find all positive samples. The f-measure is a weighted harmonic mean between the precision and recall scores and is computed as F₁=2*(precision*recall)/(precision+recall).

The Affinity Propagation method was applied with all default parameters. For the MeanShift algorithm all defaults were used. The Ward algorithm was used for hierarchal clustering and the n_clusters parameter was varied as needed. The K-means algorithm was used with default parameters, except that the n_clusters parameter was varied as needed. The BDSCAN algorithm was run with all default parameters. To evaluate cluster efficacy, six metrics were used: homogeneity, completeness, v-measure, silhouette coefficient, adjusted rand score, adjusted mutual information score. Homogeneity measures whether each cluster only contains members of a single data class. Completeness measures to what extent all measures of a given class are assigned to the same cluster. The v-measure is a harmonic mean between the completeness and homogeneity and is computed as follows: v-measure=2*(homogeneity*completeness)/(homogeneity+completeness)

The adjusted rand_score takes into account random labeling artifacts for data sets with small amounts of points. Similarly, the adjusted mutual information score is a mutual information score normalized against chance. The adjusted mutual information score measures the agreement between the true labels and the labels provided by the clustering. Regression techniques generally highlighted similar results as PCA (FIG. 8A). Regression models were evaluated across a myriad of different approaches: linear, ridge, lasso, elastic net, least angle (LARs), LARs lasso, orthogonal matching pursuit (OMP), Bayesian, Bayesian ridge, Logistic, and Stochastic Gradient Descent (SGD). The regression algorithms were all available through the Python sklearn distribution. In all cases, a grid search was run to find the best regression model for the given data set during the training phase. The data was split into a training and test set using a simple K-Fold splitting method. The models were evaluated using two criterion: the R² score and the mean squared error. The R² score, or the coefficient of determination, described how likely the model is to fit a future observation. The mean square error refers to how accurately the model fit the data. All functions were evaluated in Python using the sklearn system.

Logistic regression, being a classification method, suggested the need for multi-class prediction methods. To verify that simple network-based metrics could describe complex spatial pattern classes, various classification algorithms were assessed to determine their ability to distinguish between pattern types: k nearest neighbor (KNN), state vector machines (SVM, NuSVC), stochastic gradient descent (SGD) and decision tree algorithms.

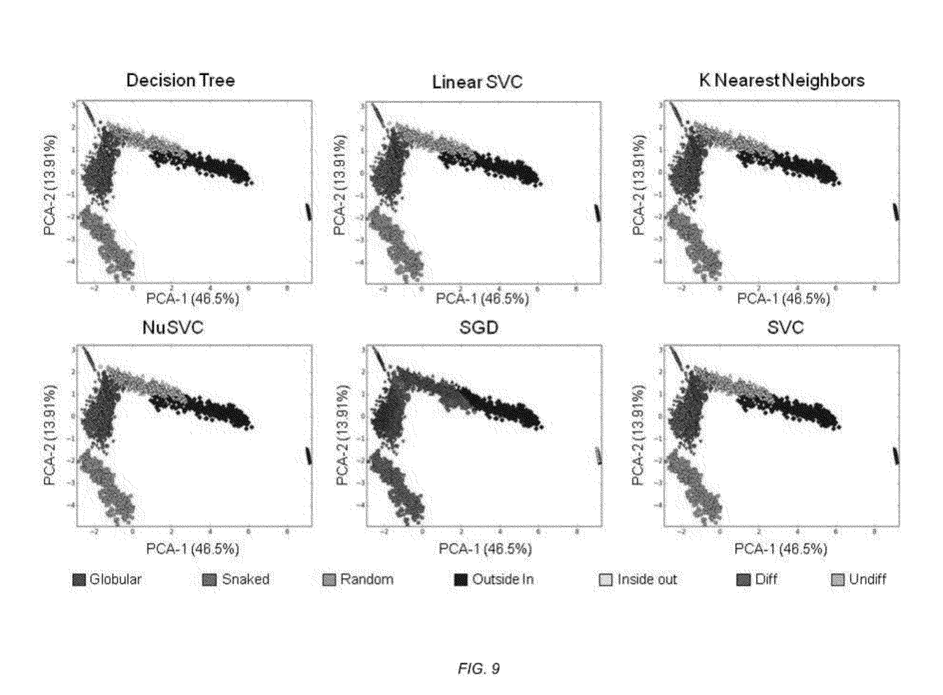

All of these algorithms correctly classified patterns with an accuracy of >0.95, except for SGD (FIG. 8B). Classifiers distinguished true negatives robustly (precision score>0.90) while also finding all positive samples (recall score>0.89). Classification labeling overlapped with the true labels as assessed via PCA dimensional reduction (FIG. 9).

3. Application in 2D Confocal Images

Importantly, all of the classifiers were determined using 3D networks; however, in subsequent applications of histological and 2D confocal images, 2D networks would need to be used. To evaluate the classification performance of the classifiers on 2D networks, 3D networks were computationally sliced into 2D sub-networks, analyzed to extract metrics, and then run through the various classification methods, e.g. FIG. 10A. FIG. 10A-E demonstrate various modes of analysis of sliced 2D networks, according to an example embodiment and how slicing a 3D network into various 2D networks does not substantially effect pattern classification accuracy. In FIG. 10A, the slicing procedure was carried out by picking a random plan passing through the center of the aggregate. All cells in this plan were then kept and created into a separate sub-network and then analyzed and classified based on extracted metrics. FIG. 10B contains example PCA plots analyzing the resulting classification of the given patterns using NuSVC (vi), Linear SVC (iii), Decision tree (i), NNK (ii), SGD (v), and SVC (vii) where NuvSVC and Linear SVC performed better than NNK, Decision tree, SGD, and SVC. FIG. 10C demonstrates the ability to correctly classify each pattern type, according to some embodiments. FIG. 10D shows the ability of each pattern classifier to incorrectly classify each pattern type, according to some embodiments. According to FIG. 10E, NuSVC was the most accurate classifier. Collectively, these data suggest that novel network-based measurements provide a robust set of metrics for classification of complex spatial patterns. The rules for the various classification methods are listed below.

### NuSVC:

nus=[1E-7, 1E-6, 1E-5, 1E-4, 1E-3, 1E-2, .1],
params=[{‘nu’:nus, ‘kernel’: [‘linear’]},
{‘nu’:nus, ‘gamma’:np.logspace(−5,0,num=6), ‘kernel’:[‘rbf’]},
{‘nu’:nus, ‘gamma’:np.logspace(−5,0,num=6), ‘degree’:np.arange(2,5), ‘kernel’: [‘poly’]},
{‘nu’:nus, ‘gamma’:np.logspace(−5,0,num=6), ‘kernel’:[‘sigmoid’]}]
   classifier=NuSVC(probability=True)
   gs=GridSearchCV(classifier, params)

### SVC:

params=[{‘C’:np.logspace(−5,5,num=11), ‘kernel’: [‘linear’]},
{‘C’:np.logspace(−5,5,num=11), ‘gamma’:np.logspace(−5,0,num=6), ‘kernel’: [‘rbf’]},
{‘C’:np.logspace(−5,5,num=11), ‘gamma’:np.logspace(−5,0,num=6), ‘degree’:np.arange(2,5), ‘kernel’:[‘poly’]},
{‘C’:np.logspace(−5,5,num=11), ‘gamma’:np.logspace(−5,0,num=6), ‘kernel’:[‘sigmoid’]}]
   classifier=SVC(probability=True)
   gs=GridSearchCV(classifier, params)

### SGD:

params=[{‘alpha’:np.logspace(−5,5,num=11), ‘loss’:[‘log’]},
{‘alpha’:np.logspace(−5,5,num=11), ‘loss’: [‘modified_huber’]},
{‘alpha’:np.logspace(−5,5,num=11), ‘loss’: [‘perceptron’]},
{‘alpha’:np.logspace(−5,5,num=11), ‘loss’: [‘squared hinge’]}]
   classifier=SGDClassifier(shuffle=True)
   gs=GridSearchCV(classifier, params)
   linear SVC:
   params=[{‘C’:np.logspace(−5,5,num=22)}]
   classifier=LinearSVC( )
   gs=GridSearchCV(classifier, params)

### K Nearest Neighbors:

params=[{‘n_neighbors’:np.arange(1,20)}]
classifier=KNeighborsClassifier( )
gs=GridSearchCV(classifier, params)

### Decision Tree:

params=[{‘criterion’:[‘entropy’], ‘max_features’:np.arange(1, len(ml))},
{‘criterion’:[‘gini’], ‘max_features’:np.arange(1, len(ml))}]
   classifier=DecisionTreeClassifier( )
   gs=GridSearchCV(classifier, params)

### C. Application of Metrics in Experimental Biology Context

1. Methods for Cell Culture and Imaging

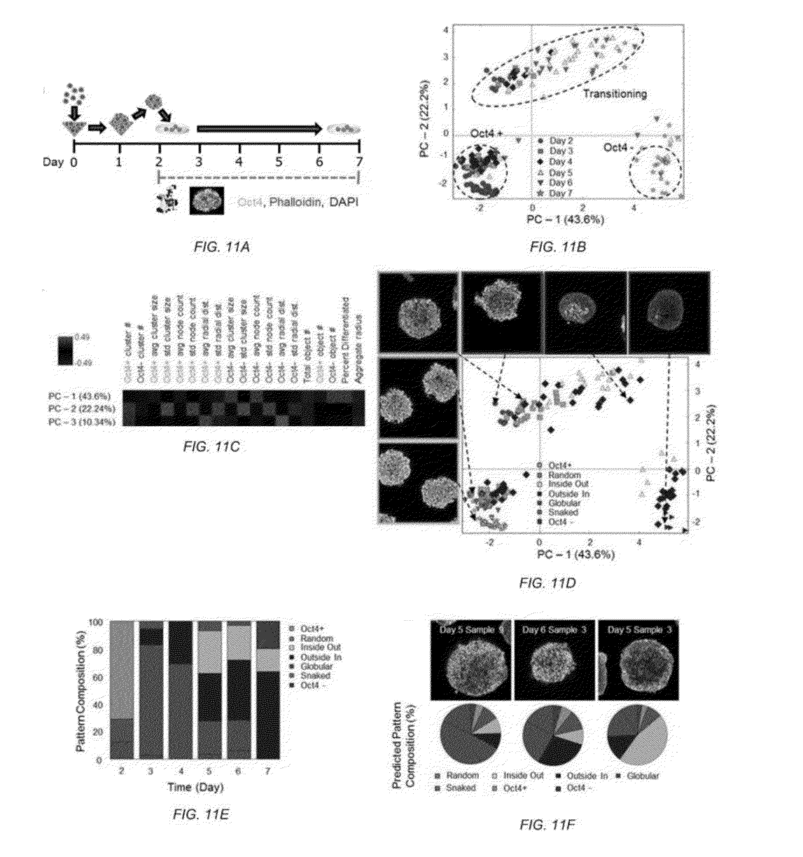

Images of Oct4+ and Oct4− transitions during differentiation of 3D murine ESC aggregates were acquired experimentally to determine how well network metrics captured an in vitro dynamic biological process (FIG. 11A). A murine embryonic stem cell line (D3) transfected with an Oct4-GFP construct was used (phOCT3-EGFP1; provided by Wei Cui, Ph.D., Imperial College, London, UK). For this particular experiment, these cells were used after several passages and splits; thus immunostaining was necessary to visualize Oct4 expression. These cells were cultured in a monolayer on 100 mm tissue culture plates coated with 0.67% gelatin in Dulbecco's modified Eagle's medium (DMEM) supplemented with 15% fetal bovine serum(FBS) (Hyclone, Logan, Utah), 2 mM L-glutamine (Mediatech), 100 U/ml penicillin, 100 ug/ml streptomyocin, and 0.25 ug/ml amphotericin (Mediatech), 1×MEM nonessential amino acid solution (Mediatech), 0.1 mM 2-mercaptoethanol (FisherChecmical, Fairlawn, N.J.), and 10³ U/ml leukemia inhibitory factor (LIF) (Chemicon Internation, Temecula, Calif.). Cells were passaged every 2-3 days prior to reaching 70% confluence.

Next an EB was formed and cultured. Undifferentiated mouse embryonic stem cells (D3 cell line) were expanded as a monolayer on 0.1% gelatin coated polystyrene plates in media composed of Dulbecco's Modified Eagle's Medium (DMEM) supplemented with 15% fetal bovine serum (FBS), penicillin (100 U/mL), streptomycin (100 μg/mL), amphotericin (0.25 mg/mL), L-glutamine (2 mM), MEM non-essential amino acids (lx), beta-mercaptoethanol (0.1 mM) and leukemia inhibitory factor (LIF; 10³ U/mL). The undifferentiated growth media was exchanged every other day and cells were passaged prior to reaching 70% confluence. To initiate ESC differentiation, a single cell solution was obtained via dissociation in 0.05% trypsin/0.53 mM EDTA solution. Embryoid bodies (EBs) were formed via forced aggregation of single cells into 400 μm diameter PDMS microwells (AggreWell), with approximately 1000 cells per well. After 20 hours of formation, EBs were removed from the microwells and maintained in suspension on a rotary orbital shaker at 65 rpm, with approximately 1500 EBs per plate³⁵. EBs were fed via gravity-induced sedimentation and exchange of 90% of the media every other day throughout the remainder of the 14-day differentiation period. EBs were formed in the standard growth media, without LIF, and were subsequently cultured in N2B27 serum-free media once transferred to the rotary. The differentiation toward mesoderm lineages was accomplished via supplementation of basal N2B27 media with BMP4 (10 ng/mL).

Following the EBs were immunostained and imaged using confocal microscopy. EBs were collected for staining and fixed in 10% formalin for 45 minutes. EBs were permeabilized for 30 minutes in 1.0% TritonX-100, re-fixed in formalin for 15 minutes, and blocked in blocking buffer (2% bovine serum albumin, 0.1% Tween-20 in PBS) for 3 hours. Samples were stained with a goat Oct4-antibody (Santa Cruz) overnight at 4° C. After three washes in blocking buffer, EBs were subsequently stained with a secondary Donkey Anti-goat Alexa Fluor 488 conjugated antibody (1:200 Santa Cruz) for 4 hours. Staining with Alexa Flour 546 Phalloidin (1:20 Molecular Probes) and Hoescht (1:100) was performed concurrently for 25 minutes. Samples were washed, resuspended in blocking buffer, and imaged using a Zeiss LSM 510 NLO Confocal Microscope using Ar, He, Ne and Chameleon lasers. A single image was taken at the top of the EB and at a depth of 30 μm into the EB. For each sample, 25 images were obtained.

2. Methods for Network Reconstruction

Next the images were converted into a network representation. The freely available program, Cell Profiler (http://www.cellprofiler.org/), was used to analyze all of the 2D samples. In the case of the confocal EB images, the following pipeline was used. First images were imported, and split into their component channels, in this case red, blue, and green. Detection of nuclei was performed using a local otsu thresholding approach, which provided a binary mask. Clumped nuclei were resolved using the intensity function, followed with the novel propagation function provided by Cell Profiler. These steps were accomplished using the Identify Primary Objects function in Cell Profiler. This led to identification of extended objects which were termed cells. In each of these objects, the green signal (indicative of Oct4 expression) was measured, and the median and mean value were reported. Additionally the number of adjacent nearest neighbors was measured in Cell Profiler. This information was then exported and read by a Python script. The script reconstructed the networks by finding the outputted number of adjacent nearest neighbors using a KDTree implementation from scipy. Images of the networks were generated using the Python Imaging library (PIL). Annotation was performed by thresholding the Oct4 intensity values received. In the case of multiple EBs per image, the networks were then split, so each individual network contained only one EB.

The simple reconstruction methods used herein rely on two assumptions. First, cells are largely spherical which allows reconstruction with a nearest neighbor KD tree. This produces artifacts in which non-adjacent cells can be joined through proximity. Second, in the 3D case where direct measurement of cell-cell contact was not performed, all cells with a certain cutoff distance were assumed to be neighbors. This was based on the roughly hexagonal distribution of cell nuclei and number of neighbors measured previously.

3. Analysis of ESC Aggregate Networks

Next, digitized ESC aggregate networks were analyzed with the aforementioned network metrics. FIG. 11A-F show an evaluation of the spatial and temporal patterns during early ESC aggregate differentiation. FIG. 11A is a timeline for an experimental plan where confocal microscopy was performed daily (on days 2-7). FIG. 11B shows a PCA trajectory for 1000-cell aggregates where dashed regions highlight the different cell states present. FIG. 11C is a heat map of the weights of each metric in relation to each principal component. FIG. 11D shows annotations for the pattern classification of each sample. FIG. 11E shows pattern compositions for each day of differentiation. FIG. 11F shows SVC classification of samples that contain aspects of multiple core pattern classes with experimental images (top row) and, predicted pattern composition (pie charts, bottom row). The predicted pattern composition is represented as a percent of the different sub-patterns contained within.

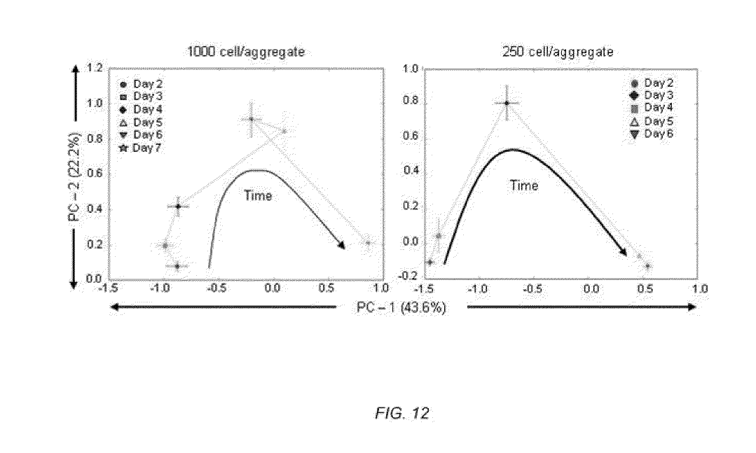

PCA revealed an average trajectory through latent variable space for cellular aggregates in which all cells began in an undifferentiated state and proceeded through a transitioning period until finally settling into a differentiated state (FIG. 11B). Regardless of size, the trajectories substantially overlapped, although the 250-cell trajectory was more truncated temporally relative to the 1000-cell aggregates, reflecting accelerated differentiation (FIG. 12). The PCA model explained 76.1% of the variance in the data: 43.6% from PC-1, 22.2% from PC-2, and 10.3% from PC-3 (FIG. 11C). All metrics significantly contributed to at least one principal component, verifying that network-derived metrics capture the variance of biological spatial patterns. PC-1 represented differentiation, while PC-2 and PC-3 again correlated with spatial sub-network descriptors representing inter-pattern variation. The principal component metric weights for the experimental data closely mirrored the weights for the in silico training set, indicating that network-derived metrics comprehensively capture the inherent biological variance that transpires during the course of ESC aggregate differentiation.

While the Oct4+ and Oct4− states were quite distinct, the intermediate transitioning period displayed a great amount of variance, as shown in FIG. 11B. To determine if the variation was due to differences in spatial patterns, classification was performed using the previously trained SVC classifier to characterize the distribution of spatial patterns in each state. Classification indicated that the initial state consisted largely of a mix of undifferentiated, random, and outside-in patterns, while the final state consisted of a mix of entirely differentiated and outside-in patterns, as shown in FIGS. 11D and 11E. The variation with respect to each time-point peaked at days 5 and 6, as seen in FIG. 11B, which also displayed a diverse set of spatial patterns, as sheen at FIG. 11E. Furthermore, SVC classification predicted that many of the aggregates at day 5 and 6 could belong to multiple pattern classes, indicating that these patterns were more spatially complex and thus displayed components of multiple different pattern types (FIG. 11F). Overall, spatial pattern evolution progressed in the following temporal order: undifferentiated, snaked, random, globular, inside-out, differentiated. Similar pattern trajectories were also observed for the 250-cell aggregates. These results represent a biological trajectory describing spatial pattern evolution in a portable quantitative fashion, but even more importantly, the analysis suggests that early differentiation in ESC aggregates progresses via quantifiable spatial patterns that do not display purely random characteristics. Furthermore, this is the first description of biological trajectories using single cell information to capture spatial pattern complexity.

### D. Analysis of Predictive Capacity of the in Silico Model

Next, to probe the mechanisms governing the formation of spatial patterns associated with differentiation, an agent-based modeling approach was employed in which cells are allowed to proliferate, move, and differentiate within a 3D aggregate configuration. Agent-based modeling approaches are gaining traction as an attractive option for modeling multicellular systems. This analysis shows that these rules produced patterns which matched the evolution of patterns in the experimental population. Though this rules-based strategy is attractive and allowed the investigation of multiple modes of regulation between local cells in terms of feedback, the probability functions do not accurately capture the kinetics of this process. The probability functions were fit such that the kinetics would match the 1000-cell/aggregate EB differentiation trajectories. However, no appreciable difference between 250-cell/aggregate and 1000-cell/aggregate simulation kinetics could be achieved, which was in contrast to experimental data.

White, et al. applied simple rules based on local neighboring cell state(s) to govern changes in cell state; however and found that comparisons between models was challenging because a set of descriptors for assessing spatial patterns did not exist. In addition, comparison with experimental data could not be directly accomplished without a digitization strategy. These challenges were addressed simultaneously by enabling direct comparison between spatial patterns from computational models and experimental results via the use of these newly defined network metrics.

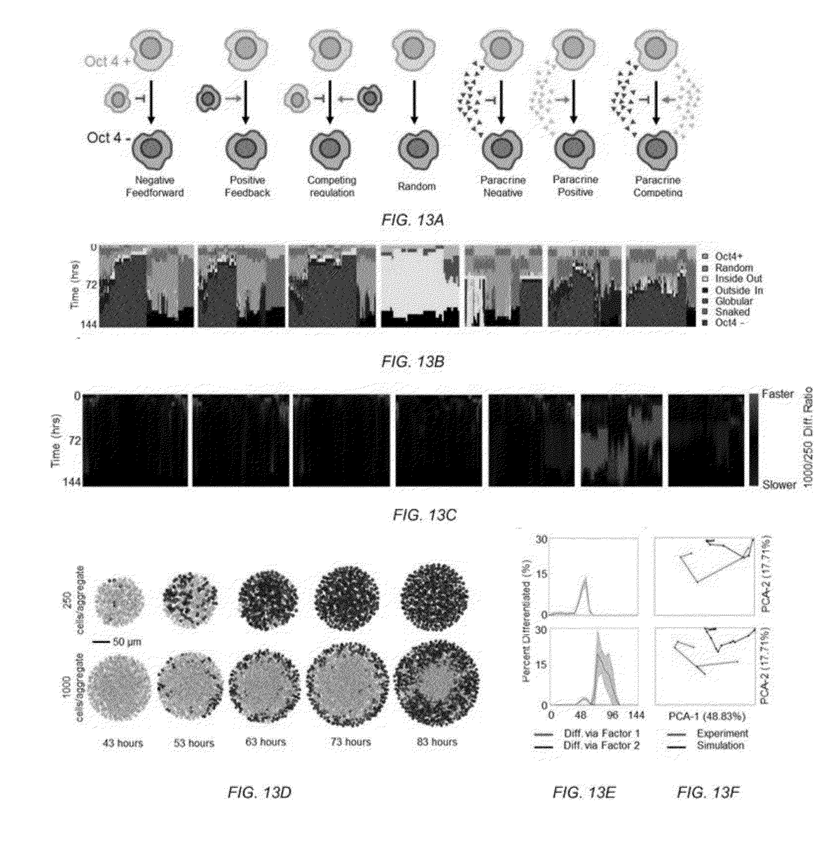

Here, seven models with different rule schemes driving differentiation were investigated: random, local positive feedback, local negative feedback, local competing regulation, paracrine activation, paracrine inhibition, and combined paracrine activation-inhibition, as shown in FIG. 13A. (Red arrows show negative feedback, green arrows show positive feedback, and small triangles indicate a soluble morphogen gradient). Diffusion simulations were carried out to understand how the ratio of consumption to production of soluble factors affected gradient propoagation prior to paracrine rule creation. Simulations were carried out with different initial cell seeding densities: 250 cells/aggregate and 1000 cells/aggregate, over a six-day period. Each rule set was simulated with multiple parameters to explore the breadth of pattern trajectory space. PCA, using the metrics described and validated in FIGS. 7 and 11, was applied to simulation time-courses. PCA captured 76.5% of the simulation variance: 48.83% from PC-1, 17.7 from PC-2, and 9.9% from PC-3. Again, PC-1 represented differentiation, while the PC-2 was influenced by standard deviations in sub-network measurements, correlating with the formation of spatial patterns in the simulations.

FIG. 13B-E show a characterization of computational pattern trajectories and comparison to experimental patterns, according to an example embodiment. The previously trained pattern classifiers were applied to assess the spatial patterns generated by the computational simulations, analyzed using hierarchical clustering, such as the Ward linkage algorithm, and annotated by rule (gray scale bar). (FIG. 13B). While the competing, negative feedforward, and positive feedback rules all generated similar pattern distributions and trajectories, the paracrine rules generated a more diverse set of pattern types. All together the rules were able to achieve a wide variety of diverse pattern types and evolutions. These results indicate that various complex pattern evolutions and temporal kinetics can be achieved using parsimonious, generalized rule sets.

### E. Comparing Model and Experimental Data

A powerful feature of the employed network-based methodology is the ability to directly compare results across different platforms, thus allowing the modeling and experimental data sets to be merged into a single metric set. PCA was used to assess which metric axes were most important for describing the variation, resulting in a set of 5 axes responsible for ˜90% of the variance along which to compare the different data sets. To identify parameter sets and rules that modulated differentiation based on aggregate size, a ratio of the differentiation rate of 250-cell to 1000-cell differentiation was calculated. FIG. 13C shows the ratio of the 1000-cell to 250-cell differentiation rate where blue represents slower differentiation in 1000-cellular aggregates, while red represents faster differentiation. This ratio confirmed that local feedback rules did not exhibit significant size-dependent differences, where nearly all of the soluble rules did. Both the paracrine activation and competing paracrine rules resulted in slower differentiation of 1000-cell aggregates than 250-cell aggregates, matching experimental observations. By comparing these rules (blue) to the experimental data (red) on the PCA axes derived previously, it was determined that the paracrine competing rule set yielded a good fit (FIG. 13F) because this rule accurately captured both the relevant time scales for differentiation (˜24 hours in 250 cells/aggregate and ˜48 hours for 1000 cells/aggregate) and the spatial pattern evolution (FIG. 13D). Furthermore, this rule suggested that, in 250-cell aggregates, differentiation was primarily induced by the absence of activator for the pluripotent state (red), while differentiation was largely caused by the accumulation of an activating factor (blue) within the 1000-cell aggregates (FIG. 13E). Collectively, these results demonstrate a non-intuitive paracrine mechanism that can accurately explain differentiation of ESC aggregates and thereby demonstrate the power and utility of network-based metrics for clarifying new mechanisms governing biological processes.

### Example 2

Histological staining can preserve native local tissue conformation and spatial information; however a major limitation with histology is that these differences are extremely hard to measure quantitatively. Known quantitative histology methods require an expert to identify regions of tissue and select them to extract information about the regions. These methods are highly prone to user error and are not high-throughput. Previous efforts to identify single cells using supervised machine learning classification have attained some success, but often require specific marker detection or rely solely on cell shape information, making them susceptible to shape-based bias from automated cellular detection algorithms. The network-based analysis was applied to data acquisition to address these challenges.

For histological analysis, EBs were collected via gravity-induced sedimentation, washed with PBS, and fixed in 10% formalin for 45 minutes under rotation. Fixed samples were subsequently encapsulated within Histogel and processed via a series of graded ethanol and xylene rinses and embedded in paraffin. Paraffin-embedded samples were sectioned using a rotary microtome (Microtom HM310) to produce 5 μm sections, which were mounted on glass slides. Histological analysis was subsequently conducted via deparaffinization in graded xylene and ethanol, followed by staining with hematoxylin and eosin (H&E). Stained sections were imaged using a Nikon Eclipse 80i microscope with a SpotFlex digital camera.

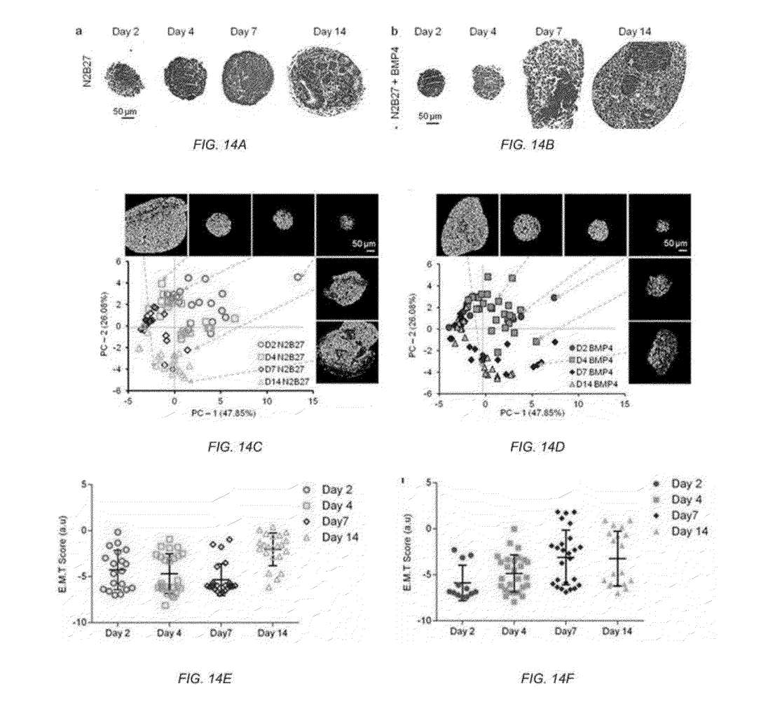

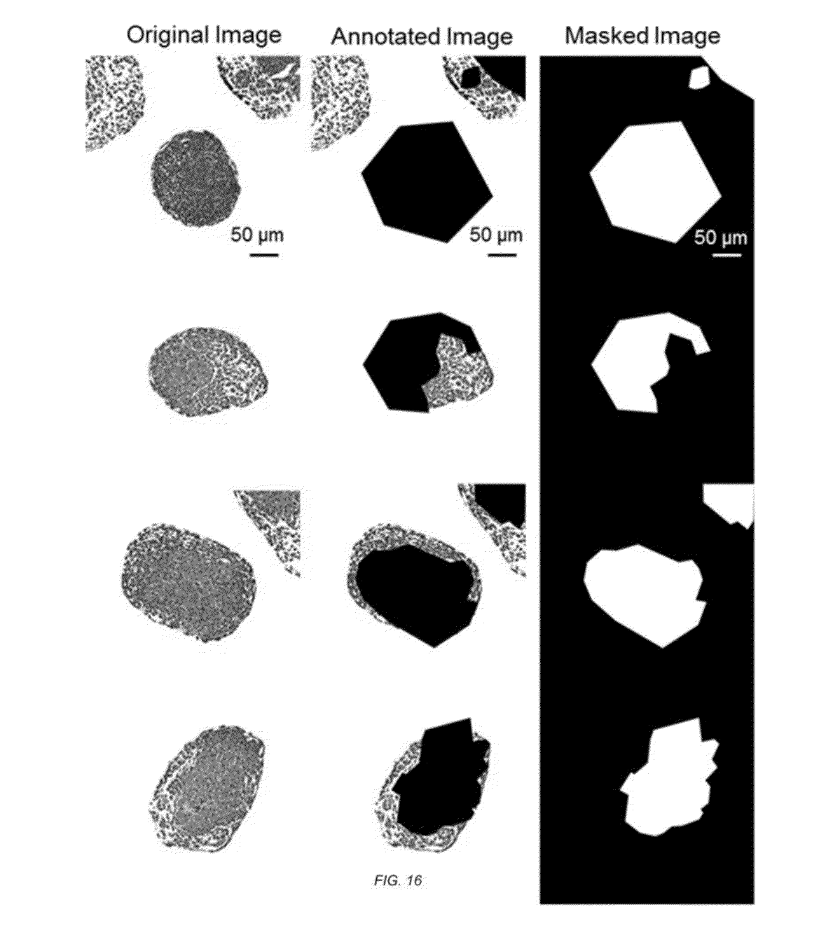

To assess how well network-based theory could quantitatively describe patterns present in histological images, ESC aggregates were stained with hematoxylin and eosin (H&E) after culture in basal serum free medium or culture with BMP4 supplementation. Immediate differences in cellular structures were observed between the treatment conditions, as shown in FIGS. 14A and 14B. (Scale bars are the same for all images (50 μm)). With BMP4 treatment, the cells adopted a more spread out mesenchymal morphology, as seen in FIG. 14B. The images were first processed using Cell Profiler and information about the geometries of the cells and nuclei were used to train classifiers, which attempted to identify tightly grouped clusters of cells from regions of cells exhibiting a more mesenchymal morphology (FIG. 16). Below is a list of metric definitions for this model.

M_clust_#—the number of mesenchymal clusters
M_size_avg—the average radius of the mesenchymal clusters
M_size_std—the standard deviation in the radius of the mesenchymal clusters
M_nd_cnt_avg—the average number of nodes of the mesenchymal clusters
M_nd_cnt_std—the standard deviation in the number of nodes of the mesenchymal clusters
M_rad_dist_avg—the average radial distance of the mesenchymal clusters
M_rad_dist_std—the standard deviation of the radial distances of the mesenchymal clusters
E_clust_#—the number of epithelial clusters
E_size_avg—the average radius of the epithelial clusters
E_size_std—the standard deviation in the radius of the epithelial clusters
E_nd_cnt_avg—the average number of nodes of the epithelial clusters
E_nd_cnt_std—the standard deviation in the number of nodes of the epithelial clusters
E_rad_dist_avg—the average radial distance of the epithelial clusters
E_rad_dist_std—the standard deviation of the radial distances of the epithelial clusters
Total_obj_#—the total number of cells in the system
Object_#_E—the total number of mesenchymal cells in the system
Object_#_M—the total number of epithelial cells in the system
Percent_diff—the total number of epithelial cells/the total number of cells
Agg_radius—the maximal radius (size) of the aggregate as measured from the center

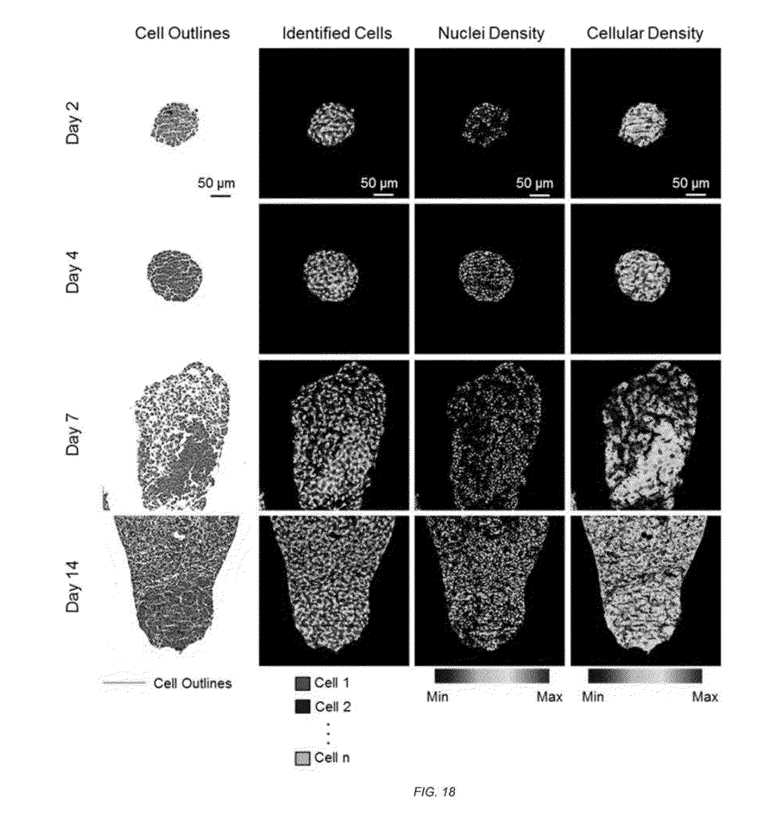

In constructing the network, a spectral unmixing algorithm from Cell Profiler was applied to extract the nuclear staining. This separated the cell cytoplasm stained with eosin, from the nuclei stained with hematoxylin. A global MCT algorithm was then used to threshold each of the samples. Nuclei were detected in the thresholded hematoxylin sample via an intensity-based method in the Identify Primary Objects module in Cell Profiler. Once the nuclei were detected, they were used as seeds for cell detection using the thresholded eosin images and the Identify Secondary Objects module in Cell Profiler. Information on the shape was then analyzed using the measure object properties module. The number of nearest neighbors was computed using the measure object neighbors module. This information was then exported to the Python script which reconstructed the networks as described above. For annotation of cell fate, a classification system was employed to use the cell and nuclei measured metrics along with network properties to classify mesenchymnal cells. (FIG. 18).

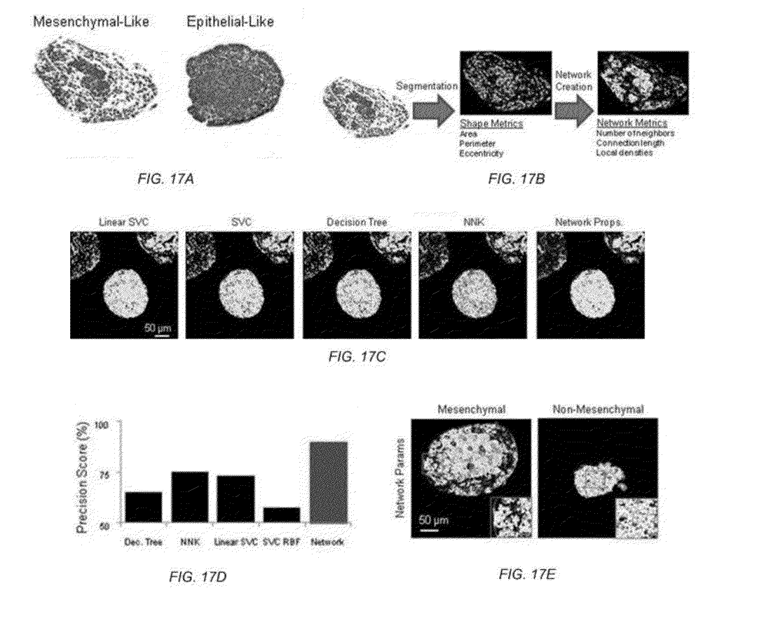

Classifiers trained with this method performed relatively poorly on average (the best being SVC at ˜75% accuracy), and over-classified cells as mesenchymal, as seen at FIG. 17C where mesenchymal cells are shown in red and epithelial cells are shown in white. However, network properties (number of neighbors or local nuclear density) showed a striking correlation with the phenotypes of interest (FIG. 17D). Classifiers trained with the addition of network properties (local nuclear densities and number of neighbors) identified mesenchymal cells (red) with greater accuracy than those without (FIG. 17E), leading to a more accurate classification (FIG. 17D) demonstrating that network-derived metrics can improve classification results when assessing individual cells.

After an accurate classifier had been trained, next the spatial and temporal distributions of two sets of sub-networks were analyzed: epithelial and mesenchymal. To eliminate excess variables in the model, feature elimination was performed, and then a PCA model was constructed. The data was split into two PCs: PC-1, which largely described the extent of differentiation, was anti-correlated with the total object number and radii; and PC-2, which represented epithelial or mesenchymal axis, was correlated with mesenchymal object number and anti-correlated with epithelial object. PCA was able to explain 73.93% of the variance: 47.85% from PC-1, and 26.08% from PC-2, as shown in FIG. 14C, where day 2 is red, day 4 is green, day 7 is blue, and day 14 is yellow. A clear evolution of multicellular patterns was evident for both the BMP4 treated and untreated conditions. While the untreated ESC aggregates appeared to become more epithelial-like with time, as seen in FIG. 14E, the BMP4 treated aggregates displayed a clearly increasing mesenchymal population peaking at day 7 (blue), which then subsequently faded at day 14 (yellow) (FIG. 14F). Overall these data suggest that network analysis can capture phenotypic differences between multicellular aggregate populations from histological sections and again display its analytic power for analyzing biologically relevant pattern trajectories acquired by a range of imaging modalities.

### Example 3

To assess the applicability of network-based analysis on a tightly regulated biological process involving multiple biological signals, gastrulation of East African cichlid fish embryos was analyzed. During gastrulation, an undifferentiated cellular aggregate undergoes coordinated multicellular movement and differentiation to yield three tissue layers, a rudimentary gut, and a neural plate. This fundamental developmental process occurs under the tight temporal and spatial control of morphogens, such as Bone Morphogenic Protein (BMP), and subsequent activation of downstream SMAD signaling via phosphorlyation (designated as pSmad). BMP signaling is initially expressed across the entire embryo but, throughout gastrulation, clears dorsally to form a pSmad gradient. The subsequent amount and rate of BMP removal correlates with expression of the homeobox gene, dlx3b. As with pSmad activity, expression of the dlx3b gene goes from being ubiquitous across the majority of the embryo to specific and strong expression in the neural plate boundary. Assessing the temporal and spatial pattern of two correlated signals during a biologically significant stage represents a powerful new application of network analysis.

Several species of East African Cichlids were kept as brooding populations in 40 gallon tanks, in two species per tank configurations, with total individuals equaling 30 to 40. Male to female ratio is typically 1 to 4 up to 1 to 10, depending on species. Fishes were allowed to spawn naturally, then broods are taken from the female's mouth approximately 24 hours post fertilization (hpf). A brood consists of 20 to 80 eggs, depending on species. Broods were grown in 150 mL flasks, in a mixture of tank water from which the mother lives, and methylene blue, to prevent fungal growth. A subset of individuals was taken from each brood at 36 hpf, and at 4-hour intervals until 48 hpf, which encompasses all of gastrulation. Embryos taken were fixed in 4% paraformaldehyde (PFA).

After fixation, expression of dlx3b was visualized using whole mount in situ hybridization, using a modification of methods previously published. The gene was visualized using Fast Red (naphthol chromogen, Roche Diagnostics). After in situ hybridization, embryos were immunostained for pSmad 1,5,8 protein, using previously published protocols³⁸. Embryos were then bathed in Vectashield (Vector Labs) containing DAPI and placed in a specially built mold that holds the embryo upright. Embryos were then scanned using a Zeiss LSM 700-405 confocal microscope and processed using LSM 700 software and Image J.

To analyze the 3D confocal stacks, a set of freely available programs were used. First the confocal images were read by ImageJ, merged into a single channel, and then saved as a image sequence. This image sequence was read using Python and converted into a memory mapped array via the numpy package. This memory mapping allows for analysis of large arrays which would normally take a large space into memory. The images were then split into their respective red, green, and blue components. The image was then denoised using a Gaussian filter from scipy's ndimage package. Initial thresholding was performed on the blue channel using a global Otsu approach from the Python package skimage. This lead to identification of grouped nuclei. To segment nuclei, local maxima detection was performed using the Python package skimage. Once initial maxima had been detected, a merging step was performed to identify local maxima which were too close to each other, and these were merged into a single new local maxima point to be used as a seed points. These points were then converted into seeds for nuclei detection and served as the subsequent nodes in the network. Connections were formed using a nearest neighbor approach using a KD Tree implementation from scipy, in which only neighbors within a certain distance (twice the cell radius) were kept. The cells were then annotated by computing the average red and green values within radii around the points. A global threshold over all images was established for the red and green channels using an Otsu thresholding approach over all of the nodes. The networks were then filtered to remove unconnected sub-networks, and further filtered using a quality metric which excluded all nodes with a low blue signal which produced the final annotated network.

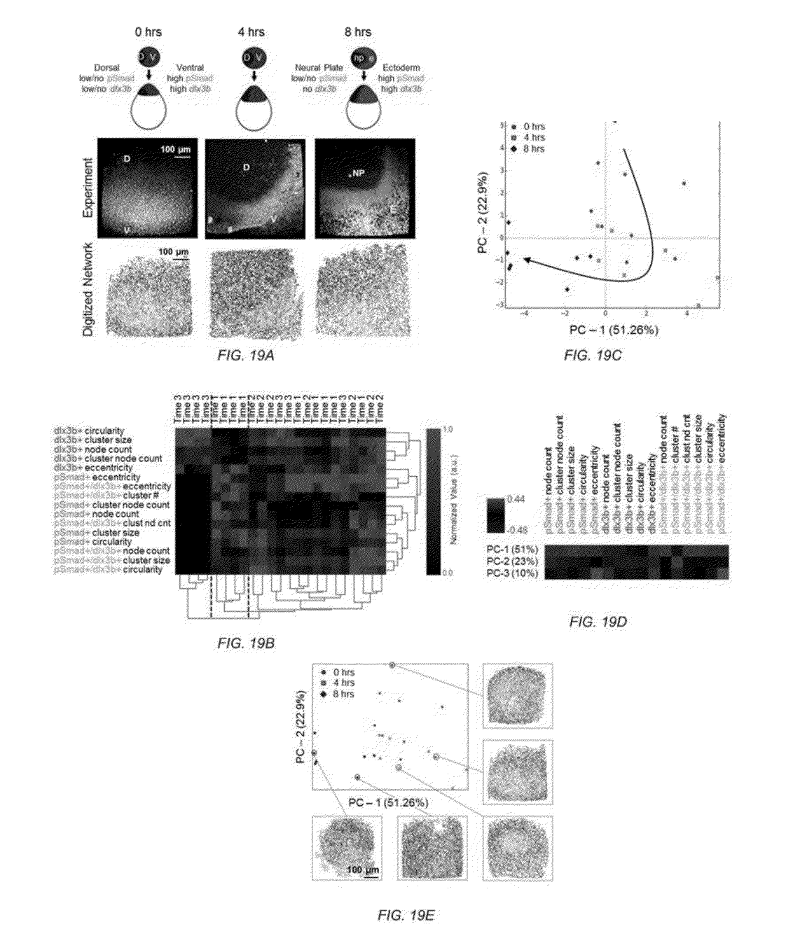

The inherent 3D structure of cichlids presented a challenge, thus a 3D segmentation algorithm was implemented to output annotated spatial networks (FIG. 19). Using the previously defined metrics, three separate sub-networks of cells were analyzed: pSmad+, dlx3b+ and pSmad+/dlx3b (FIG. 19A). FIG. 19A shows a representative schematic of gastrulation in cichlids on top, experimental confocal data in middle (red—dlx3b, green—pSmad, blue DAPI, yellow pSmad+/dlx3b+) followed by network reconstructions on the bottom (red—dlx3b, green—pSmad, blue DAPI, yellow pSmad+/dlx3b). Scale bars are 100 μm. In addition, several new pattern classification metrics were added, such as the ratio of pSmad+/dlx3b+ nodes to dlx3b+ nodes and pSmad+ nodes, as well as circularity and eccentricity measures for cell clusters in an effort to capture the additional spatial complexity of this system. To identify relevant metrics feature extraction analysis was performed. Below is a list of metric definitions for this model.

dlx3b+_clust_#—the number of dlx3b+ clusters
dlx3b+_size_avg—the average radius of the dlx3b+ clusters
dlx3b+_size_std—the standard deviation in the radius of the dlx3b+ clusters
dlx3b+_nd_cnt_avg—the average number of nodes of the dlx3b+ clusters
dlx3b+_nd_cnt_std—the standard deviation in the number of nodes of the dlx3b+ clusters
dlx3b+_rad_dist_avg—the average radial distance of the dlx3b+ clusters
dlx3b+_rad_dist_std—the standard deviation of the radial distances of the dlx3b+ clusters
dlx3b+_clust_circ_avg—the average circularity of the dlx3b+ clusters
dlx3b+_clust_circ_std—the standard deviation of the circularities of the dlx3b+ clusters
dlx3b+_ecc_avg—the average eccentricity of the dlx3b+ clusters
dlx3b+_ecc_std—the standard deviation of the eccentricities of the dlx3b+ clusters
pSmad+_clust_#—the number of pSmad+ clusters
pSmad+_size_avg—the average radius of the pSmad+ clusters
pSmad+_size_std—the standard deviation in the radius of the pSmad+ clusters
pSmad+_nd_cnt_avg—the average number of nodes of the pSmad+ clusters
pSmad+_nd_cnt_std—the standard deviation in the number of nodes of the pSmad+ clusters
pSmad+_rad_dist_avg—the average radial distance of the pSmad+ clusters
pSmad+_rad_dist_std—the standard deviation of the radial distances of the pSmad+ clusters
pSmad+_clust_circ_avg—the average circularity of the pSmad+ clusters
pSmad+_clust_circ_std—the standard deviation of the circularities of the pSmad+ clusters
pSmad+_ecc_avg—the average eccentricity of the pSmad+ clusters
pSmad+_ecc_std—the standard deviation of the eccentricities of the pSmad+ clusters
pSmad+/dlx3b+_clust_#—the number of pSmad+/dlx3b+ clusters
pSmad+/dlx3b+_size_avg—the average radius of the pSmad+/dlx3b+ clusters
pSmad+/dlx3b+_size_std—the standard deviation in the radius of the pSmad+/dlx3b+ clusters
pSmad+/dlx3b+_nd_cnt_avg—the average number of nodes of the pSmad+/dlx3b+ clusters
pSmad+/dlx3b+_nd_cnt_std—the standard deviation in the number of nodes of the pSmad+/dlx3b+ clusters
pSmad+/dlx3b+_rad_dist_avg—the average radial distance of the pSmad+/dlx3b+ clusters
pSmad+/dlx3b+_rad_dist_std—the standard deviation of the radial distances of the pSmad+/dlx3b+ clusters
pSmad+/dlx3b+_clust_circ_avg—the average circularity of the pSmad+/dlx3b+ clusters
pSmad+/dlx3b+_clust_circ_std—the standard deviation of the circularities of the pSmad+/dlx3b+ clusters
pSmad+/dlx3b+_ecc_avg—the average eccentricity of the pSmad+/dlx3b+ clusters
pSmad+/dlx3b+_ecc_std—the standard deviation of the eccentricities of the pSmad+/dlx3b+ clusters
pSmad+/dlx3b+_r_ratio—r_clust_nd_count_avg/y_clust_nd_count_avg
pSmad+/dlx3b+_g_ratio—r_clust_nd_count_avg/y_clust_nd_count_avg
Total_obj_#—the total number of cells in the system
Object_#_pSmad+/dlx3b+—the total number of pSmad+/dlx3b+ cells in the system
Object_#_dlx3b+—the total number of dlx3b+ cells in the system
Object_#_{—} pSmad+—the total number of pSmad+ cells in the system
Agg_radius—the maximal radius (size) of the aggregate as measured from the center

Initial hierarchical clustering analysis of the resulting metrics revealed segregation of the data set into three main clusters, but the majority of the data set fell into a single large cluster that made subsequent interpretation difficult, as shown at FIG. 19B. Thus, in order to analyze the clusters further, a PCA model (n>=7 per time point) was created that explained the majority (83.8%) of the variance: 51.3% from PC-1, 22.9% from PC-2, and 9.6% from PC3 (FIG. 19C). PC-1 correlated highly with metrics associated with the shape of pSmad+ and pSmad+/dlx3b+ clusters, while PC-2 was strongly inversely correlated with dlx3b+ cluster metrics, and PC-3 correlated with eccentricities metrics.

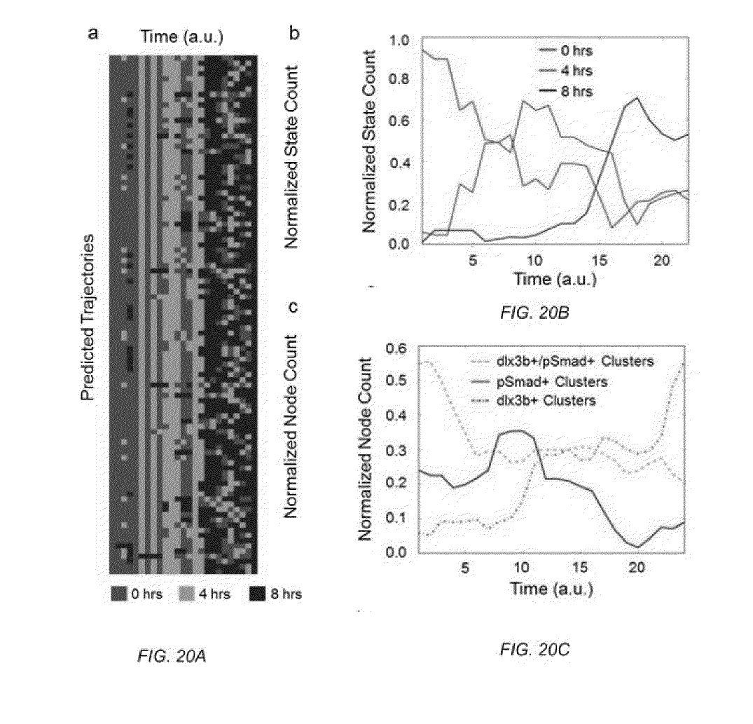

This final PCA model not only revealed the initial and terminal states detected by hierarchical clustering, but more importantly, resolved the remaining data along a clear temporal trajectory, as seen at FIG. 19C (0 hours—red circle, 4 hours—green square, 8 hours—blue diamond). Selecting various points along the trajectory revealed a set of patterns that matched the known biology, while also identifying subtle transition states between discrete time points (FIG. 19E). Early development time points (0 hours-4 hours) were characterized by a shrinking pSmad+ region with an increase in dlx3b+/pSmad+ regions, as indicated by the shift primarily in early time points along PC-2. The midpoint of gastrulation (˜4 hours) exhibited an important switch in the formation and shape of the dlx3b+ region, and the final developmental stage (4 hours-8 hours) was heavily influenced by the emergence of a crescent of dlx3b expression, as indicated by its progression along the PC-1 axis. To test how well these metrics predicted the evolution, a set of path finding simulations intended to find the most likely flow of information through a given process were performed (FIG. 20A). The average trajectory for these simulations indicated the 0 hours samples (red) peaking first, followed by a peak in the 4 hour (green), and 8 hour samples (blue) (FIG. 20B). Analysis of the clusters indicated that early samples were marked by a high level of pSmad+ and pSmad+/dlx3b+ regions, followed by a gradual increase in the presence of solely dlx3b+ clusters (FIG. 20C). Taken together, these results indicate that the biological trajectory produced by this approach can distinguish the precise state of gastrulation of a biological sample regardless of the experimental time point at which it was acquired during the process (FIGS. 19C, 19E, and 19B), further demonstrating the unique strength of a quantitative network-based pattern classification approach for more accurately analyzing morphogenic processes.

Although preferred embodiments of the disclosure have been explained in detail, it is to be understood that other embodiments are contemplated. Accordingly, it is not intended that the disclosure is limited in its scope to the details of construction and arrangement of components set forth in the following description or illustrated in the drawings. The disclosure is capable of other embodiments and of being practiced or carried out in various ways. Also, in describing the preferred embodiments, specific terminology will be resorted to for the sake of clarity.

It must also be noted that, as used in the specification and the appended claims, the singular forms “a,” “an” and “the” include plural referents unless the context clearly dictates otherwise.

Also, in describing the preferred embodiments, terminology was resorted to for the sake of clarity. It is intended that each term contemplates its broadest meaning as understood by those skilled in the art and includes all technical equivalents which operate in a similar manner to accomplish a similar purpose.

Ranges may have be expressed herein as from “about” or “approximately” one particular value and/or to “about” or “approximately” another particular value. When such a range is expressed, another embodiment includes from the one particular value and/or to the other particular value.

By “comprising” or “containing” or “including” it is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

1. A method for analyzing cell spatial trajectories comprising
receiving, at a processor, data representative of a cellular aggregate image wherein the cellular aggregate image represents a plurality of individual cells;
identifying, by the processor, cell image data associated with each cell of the plurality of individual cells
constructing, by the processor, a network representation associated with the cellular aggregate image;
identifying, by the processor, one or more metrics corresponding to a first cell spatial property;
determining, by the processor, a correlation between the one or more metrics corresponding to the first cell spatial property and data representative of a period of time; and
outputting, for display, data representative of a plot demonstrating the correlation between the one or more metrics and the period of time.

2. The method of claim 1 wherein the network representation comprises interconnected nodes, each node representing one or more cells of the plurality of individual cells.

3. The method of claim 2 wherein the nodes are interconnected by identifying, by the processor, a first node and a nearest neighbor second node and constructing, by the processor, a connector between the first node and the second node.

4. The method of claim 2 wherein identifying the one or more metrics corresponding to the first cell spatial property comprises determining, by the processor, a distance between two nodes.

5. The method of claim 2 wherein identifying the one or more metrics corresponding to the first cell property comprises determining, by the processor, the number of nodes in the network representation.

6. The method of claim 2 further comprising applying, by the processor, an image processing technique to identify a cellular characteristic.

7. The method of claim 6 further comprising annotating, by the processor, the network representation with tags corresponding to the cellular characteristic

8. The method of claim 7 wherein identifying the metrics corresponding to the first cell property comprises determining the number of nodes annotated with the tags corresponding to the cellular characteristic.

9. The method of claim 6 further comprising
identifying, by the processor, a sub-network of the network representation based at least in part on the cellular characteristic;
identifying, by the processor, one or more metrics corresponding to a second cell spatial property;
determining, by the processor, a correlation between the one or more metrics corresponding to the second cell spatial property and data representative of a period of time; and
outputting, for display, data representative of a plot demonstrating the correlation between the one or more metrics and the period of time.

10. The method of claim 9 wherein a clustering algorithm is used to identify one or more cell clusters.

11. The method of claim 10 wherein identifying the one or more metrics corresponding to the second cell spatial property comprises determining, by the processor, the size of the cluster.

12. The method of claim 10 wherein identifying the one or more metrics corresponding to the second cell spatial property comprises determining, by the processor, the number of cells in the cluster.

13. The method of claim 10 wherein identifying the one or more metrics corresponding to the second cell spatial property comprises determining, by the processor, the number of cells in the cluster with the cellular characteristic.

14. The method of claim 1 wherein the cellular aggregate image represents an in silico model with a plurality of incompressible spheres representing the individual cells.

15. The method of claim 1 wherein identifying the individual cells further comprises
conducting, by the processor, an initial image processing technique; and
applying, by the processor, an image thresholding method.

16. The method of claim 15 wherein the initial image processing techniques comprise splitting the cellular aggregate image into two or more channels.

17. The method of claim 15 wherein the initial image processing comprises applying a Guassian filter to the cellular aggregate image.

18. The method of claim 15 wherein the thresholding method comprises a global Otsu approach.

19. A non-transient computer readable medium containing program instructions for causing a computer to perform the method of
receiving data representative of a cellular aggregate image wherein the cellular aggregate image represents a plurality of individual cells;
identifying cell image data associated with each cell of the plurality of individual cells
constructing a network representation associated with the cellular aggregate image;
identifying one or more metrics corresponding to a first cell spatial property;
determining a correlation between the one or more metrics corresponding to the first cell spatial property and data representative of a period of time; and
outputting, for display, data representative of a plot demonstrating the correlation between the one or more metrics and the period of time.

20. The method of claim 19 further comprising
applying an image processing technique to identify a cellular characteristic;
identifying a sub-network of the network representation based at least in part on the cellular characteristic;
identifying one or more metrics corresponding to a second cell spatial property;
determining a correlation between the one or more metrics corresponding to the second cell spatial property and data representative of a period of time; and
outputting, for display, data representative of a plot demonstrating the correlation between the one or more metrics and the period of time.
